(19) United States
(12) Patent Application Publication
(10) Pub. No.: US 2023/0201934 A1
(43) Pub. Date: Jun. 29, 2023

(54) WORK MACHINE

(71) Applicant: Koki Holdings Co., Ltd., Tokyo (JP)

(72) Inventor: Yusuke FUNABIKI, Ibaraki (JP)

(73) Assignee: Koki Holdings Co., Ltd., Tokyo (JP)

(21) Appl. No.: 17/926,628

(22) PCT Filed: May 28, 2021
(86) PCT No.: PCT/JP2021/020430

§ 371 Date: Nov. 21, 2022

(30) Foreign Application Priority Data
May 29, 2020 (JP) 2020-093973

(51) Int. Cl. B23D 45/16; B23D 59/00; B23Q 11/08

(52) U.S. Cl. CPC B23D 45/16; B23D 59/006; B23Q 11/08

(57) ABSTRACT

Provided is a work machine with improved operatability. In a cutting tool, a guard member that is made of metal is provided inside a chip discharge passage section, and a bottom wall of the chip discharge passage section on a saw blade side is covered by the guard member. In other words, a bottom surface of the chip discharge passage section is guarded by the guard member that is made of metal. Accordingly, the guard member can prevent high-temperature metal chips from coming into direct contact with the bottom wall of the chip discharge passage section. Thus, deformation of the chip discharge passage section when chips pass through the chip discharge passage section can be suppressed. Consequently, the durability of a saw cover can be increased, and the operatability of the cutting tool can be improved.

### TECHNICAL FIELD

The present invention relates to a work machine.

### BACKGROUND ART

The following Patent Literature 1 discloses a portable circular saw (work machine) including a dust box (dust collection box). The dust box is configured to be disposed on a lateral side of a saw cover covering a circular saw blade and store chips generated during operation of the portable circular saw inside the dust box.

### CITATION LIST

### Patent Literature

### [Patent Literature 1]

Japanese Patent Application Laid-Open No. 2011-68073

### SUMMARY OF INVENTION

### Technical Problem

Here, when a machining material to be machined using a portable circular saw is a metal such as a mild steel, chips generated during cutting may become hard and have a high temperature. For this reason, when chips come into contact with a portion of a portable circular saw, there is concern that a contact location may be affected due to vigor of chips or heat of chips. For example, there is a likelihood that a saw cover or a dust collection box will be damaged or thermally deformed due to chips. When a portion of a saw cover covering a space in which a circular saw blade is driven is deformed and protrudes into the space in which the circular saw blade rotates, there is concern that workability may deteriorate due to interference between a portion of the deformed saw cover and a portion of the rotating circular saw blade. In addition, when the inside of a space through which chips pass or are collected is deformed, there is concern that workability may deteriorate because a likelihood of chips adhering to an inner wall of the space has increased or chips are no longer able to pass through or be collected normally. Accordingly, it is desired that work machines have a constitution in which deformation due to chips is unlikely to occur. In addition, there is concern that visibility may be degraded, normal movement of movable components may be hindered, and workability may deteriorate due to adherence and accumulation of chips at predetermined locations.

In consideration of the foregoing circumstances, the present invention provides a work machine capable of curbing deterioration in workability due to machining chips generated during work.

### Solution to Problem

A work machine according to one or more embodiments of the present invention includes a motor for driving a tip tool, a cover covering at least a portion of the tip tool, a discharge passage section provided in the cover and discharging machining chips generated during machining work using the tip tool, and a guard member positioned inside the discharge passage section and covering a wall part on the tip tool side in the discharge passage section.

In the work machine according to one or more embodiments of the present invention, a dust collection box for storing machining chips discharged from the discharge passage section is attached to the cover.

In the work machine according to one or more embodiments of the present invention, the discharge passage section has an entrance part opening to the tip tool side, and an exit part opening to the dust collection box side. The guard member is provided inside a path leading from the entrance part to the exit part.

In the work machine according to one or more embodiments of the present invention, the dust collection box is configured to include a first case disposed adjacent to the cover, and a second case covering the first case from a side opposite to the cover. The first case is made of a metal, and the second case is made of a transparent material.

In the work machine according to one or more embodiments of the present invention, the first case is provided with a stopper part in which machining chips discharged to the dust collection box from the discharge passage section abut.

In the work machine according to one or more embodiments of the present invention, a cover part covering a portion on an inner circumferential surface of the second case is formed in the first case.

In the work machine according to one or more embodiments of the present invention, the cover part covers at least a portion on an inner circumferential surface of a lower wall of the second case.

In the work machine according to one or more embodiments of the present invention, the second case is constituted using a resin material.

In the work machine according to one or more embodiments of the present invention, a portion of the guard member extends to the dust collection box side beyond the discharge passage section.

In the work machine according to one or more embodiments of the present invention, the discharge passage section is provided with a guide wall for guiding the flowing machining chips to the dust collection box side. The guard member is provided with a guide cover covering at least a portion of the guide wall. In the work machine according to one or more embodiments of the present invention, the guard member is provided with an entrance guide part for curbing separation of the machining chips from the entrance part of the discharge passage section. In the work machine according to one or more embodiments of the present invention, the guard member is made of a metal.

A work machine according to one or more embodiments of the present invention includes a first space having a tip tool driven by a motor positioned therein, a second space including at least one of a passage space through which machining chips generated during work by the tip tool pass or an accommodation space in which the machining chips are collected, and a partitioning part partitioning the first space and the second space. A protective member is provided in a region between the first space and the partitioning part, a region between the second space and the partitioning part, or the partitioning part. In the work machine according to one or more embodiments of the present invention, the protective member is harder or has higher heat resistance than the partitioning part or has both the properties. In the work machine according to one or more embodiments of the present invention, the protective member is provided such that the protective member is provided in the region between the first space and the partitioning part and at least a portion is exposed to the first space or the protective member is provided in the region between the second space and the partitioning part and at least a portion is exposed to the second space. In the work machine according to one or more embodiments of the present invention, the protective member is attached to the partitioning part. The work machine according to one or more embodiments of the present invention further includes a cover covering at least a portion of the tip tool. The partitioning part is provided in the cover.

A work machine according to one or more embodiments of the present invention includes a motor for driving a tip tool, a cover covering at least the tip tool from one side of the motor in an axial direction, a discharge passage section provided in the cover and discharging machining chips generated during machining, and a dust collection box provided on one side of the motor in the axial direction with respect to the cover and storing machining chips discharged from the discharge passage section. At least a portion of a box-side facing part of the dust collection box facing the cover in the axial direction of the motor is made of a metal. In the work machine according to one or more embodiments of the present invention, the cover is provided with a cover-side facing part facing the box-side facing part. The cover-side facing part is provided with a ventilation hole for generating an air flow between the box-side facing part and the cover-side facing part. In the work machine according to one or more embodiments of the present invention, a plurality of ventilation holes is formed in the cover-side facing part of the cover facing the dust collection box in the axial direction of the motor. In the work machine according to one or more embodiments of the present invention, an abutment rib protruding to the box-side facing part side is formed in the cover-side facing part. In the work machine according to one or more embodiments of the present invention, the cover-side facing part is formed to have a semicircular fan shape having a clearance part opening to a lower side when viewed in the axial direction of the motor. The ventilation hole is disposed on an outward side of the clearance part in a radial direction. In the work machine according to one or more embodiments of the present invention, a portion of the box-side facing part constitutes a bottom part inside the dust collection box. In the work machine according to one or more embodiments of the present invention, the dust collection box has an outer case covering the box-side facing part from a side opposite to the cover. The outer case is made of a resin. In the work machine according to one or more embodiments of the present invention, the dust collection box is provided with an attachment/detachment button configured to be able to engage with the cover. A position of the attachment/detachment button is set by the box-side facing part. In the work machine according to one or more embodiments of the present invention, a metal member is provided in the bottom part inside the dust collection box. The metal member and the box-side facing part are connected to each other.

### Advantageous Effects of Invention

According to one or more embodiments of the present invention, it is possible to improve heat resistance.

### BRIEF DESCRIPTION OF DRAWINGS

FIG. 1 is a side view illustrating a cutting tool according to the present embodiment viewed from the right side.

FIG. 2 is a side view of the cutting tool illustrated in FIG. 1 viewed from the left side.

FIG. 3 is a perspective view of the cutting tool illustrated in FIG. 1 viewed obliquely from the right in the front.

FIG. 4 is a perspective view illustrating a state in which a dust collection box of the cutting tool illustrated in FIG. 3 is detached from a tool main body and viewed obliquely from the right in the front.

FIG. 5 is a perspective view illustrating a state in which a duct of the cutting tool illustrated in FIG. 3 is detached from a motor housing part and viewed obliquely from the left in the front.

FIG. 6 is a cross-sectional view illustrating the inside of the cutting tool illustrated in FIG. 2 viewed from the upper side (a cross-sectional view along line 6-6 in FIG. 2).

FIG. 7 is a perspective view illustrating a positional relationship between a saw cover of the cutting tool illustrated in FIG. 4 and a saw blade and viewed obliquely from the left in the front.

FIG. 8 is a cross-sectional view of a part of a chip discharge passage section of the saw cover illustrated in FIG. 7 viewed from the right side.

FIG. 9 is a cross-sectional view of the inside of the chip discharge passage section illustrated in FIG. 8 viewed obliquely from above in the front (a cross-sectional view along line 9-9 in FIG. 8).

(A) of FIG. 10 is a cross-sectional view of a part of a box-side intake part of the dust collection box illustrated in FIG. 1 viewed from the front side (a cross-sectional view along line 10A-10A in FIG. 1), and (B) of FIG. 10 is a cross-sectional view of a part of an attachment/detachment button of the dust collection box illustrated in FIG. 1 viewed from the front side (a cross-sectional view along line 10B-10B in FIG. 1).

FIG. 11 is a perspective view illustrating a guard member in its entirety illustrated in FIG. 4 and viewed obliquely from the right in the front.

FIG. 12 is an exploded perspective view of the dust collection box illustrated in FIG. 4 viewed obliquely from the left in the rear.

FIG. 13 is a perspective view illustrating a positional relationship between an inner case of the dust collection box illustrated in FIG. 12 and the saw cover and viewed obliquely from the right in the front.

FIG. 14 is a perspective view of a saw cover according to a modification example and a dust collection box in a state of being attached to the saw cover viewed in a left forward direction.

FIG. 15 is a partially enlarged perspective view of the constitution illustrated in FIG. 14 viewed from the lower left in the rear.

FIG. 16 is a perspective view illustrating a state in which the saw cover and the inner case are detached from the constitution illustrated in FIG. 14.

FIG. 17 is a perspective view illustrating a partial cross section of the constitution illustrated in FIG. 14.

FIG. 18 is a perspective view illustrating a state in which an outer case is detached from the constitution illustrated in FIG. 14.

### DESCRIPTION OF EMBODIMENT

Hereinafter, using the drawings, a cutting tool 10 serving as a work machine according to the present embodiment will be described. An arrow UP, an arrow FR, and an arrow RH suitably indicated in the drawings respectively indicate the upper side, the front side, and the right side of the cutting tool 10. Further, when directions to the upper and lower sides, the front and rear sides, and the left and right sides are used in the following description, they respectively indicate an upward-downward direction, a forward-rearward direction, and a lateral direction of the cutting tool 10 unless otherwise particularly stated.

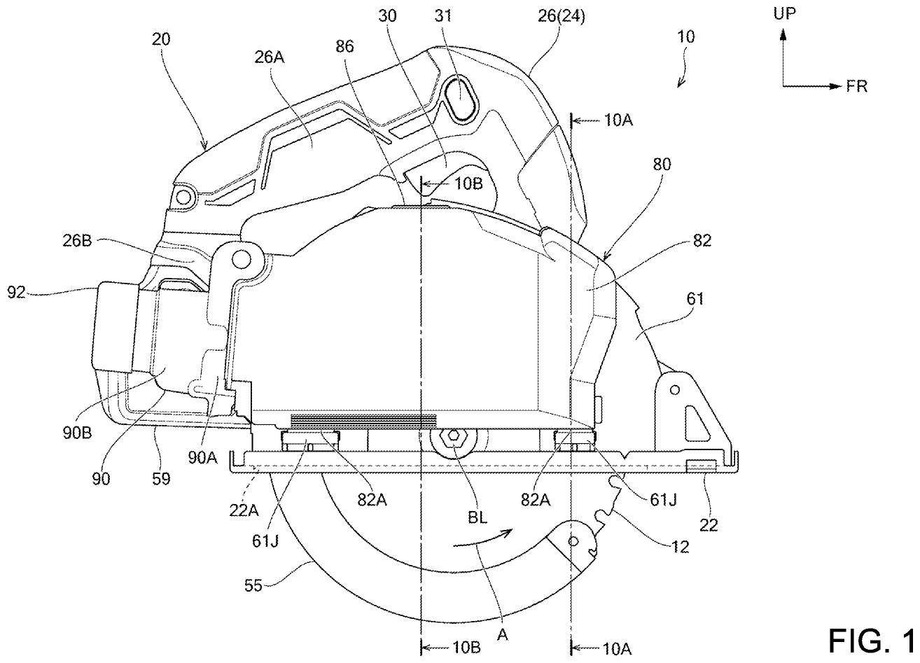

The cutting tool 10 is configured to serve as a tool for cutting a machining material. As illustrated in FIGS. 1 to 4, the cutting tool 10 is configured to include a tool main body 20 for performing cutting with respect to a machining material, and a dust collection box 80 for storing chips which are machining chips generated during machining. Hereinafter, first, a constitution of the tool main body 20 will be described. Next, a constitution of the dust collection box 80 will be described.

(Regarding Tool Main Body 20)

The tool main body 20 is configured to include a base 22, a housing 24, a drive mechanism 40 and a control part 57 accommodated inside the housing 24, a battery pack 59, a saw cover 60 serving as a cover, and a guard member 70 serving as a protective member.

(Regarding Base 22)

The base 22 is formed to have a substantially rectangular plate shape having the upward-downward direction as a plate thickness direction and having the forward-rearward direction as a longitudinal direction. Further, during machining by the cutting tool 10, the base 22 is placed on the upper side of the machining material, and a lower surface of the base 22 is caused to slide along an upper surface of the machining material.

In the left side part of the base 22, a tool insertion part 22A for disposing a saw blade 12 serving as a tip tool is formed in a penetrating manner, and the tool insertion part 22A is formed to have a substantially rectangular hole shape having the forward-rearward direction as the longitudinal direction in a plan view. Here, the saw blade 12 is formed to have a substantially circular plate shape having the lateral direction as the plate thickness direction, and a central part of the saw blade 12 is fixed to an output shaft 50 of the drive mechanism 40 (which will be described below) in an integrally rotatable manner. Further, the saw blade 12 is disposed inside the tool insertion part 22A, an upper part of the saw blade 12 protrudes from the base 22 to the upper side, and a lower end side portion of the saw blade 12 protrudes from the base 22 to the lower side.

(Regarding Housing 24)

As illustrated in FIGS. 1 to 6, the housing 24 constitutes the contour of the tool main body 20 and is disposed on the upper side of the base 22. The housing 24 is configured to include a main body housing part 25 for accommodating the drive mechanism 40 (which will be described below), a handle housing part 26 constituting the upper part of the housing 24, and a duct 27.

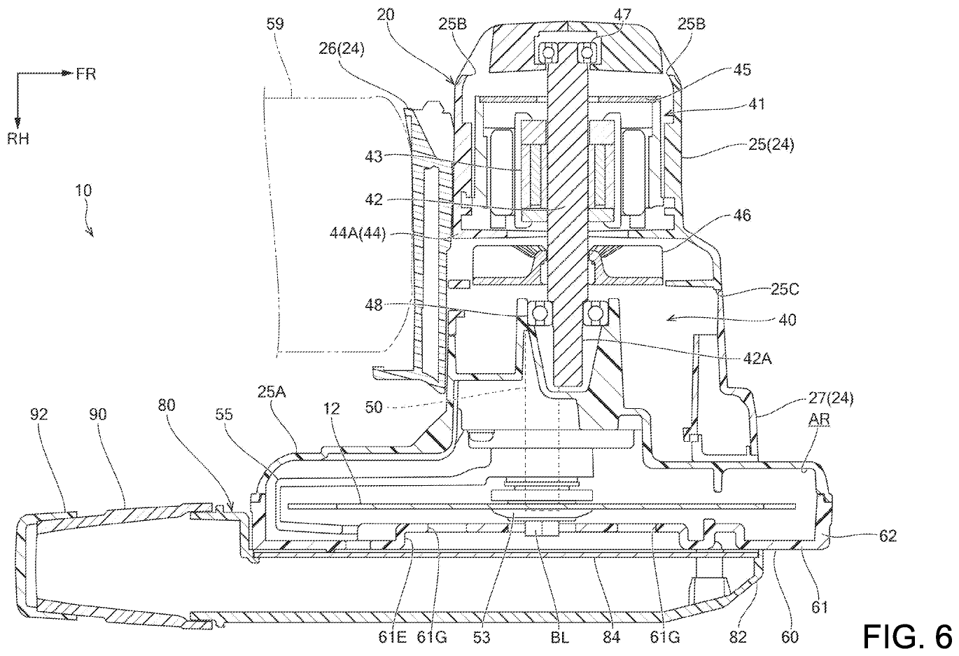

The main body housing part 25 is formed to have a substantially bottomed cylindrical shape opening to the right side. A housing-side cover part 25A projecting to the outward side in a radial direction is formed in the right end part of the main body housing part 25. The housing-side cover part 25A is formed to have a substantially semicircular shape sticking out to the upper side when viewed from the right side, and an outer circumferential part of the housing-side cover part 25A is bent to the left side (refer to FIG. 6). Further, the front end part and the rear end part of the housing-side cover part 25A are coupled to the base 22.

In the left end part of the main body housing part 25, a plurality of intake ports 25B is formed in a penetrating manner at corner parts on the front side and the rear side. The plurality of intake ports 25B is formed throughout the main body housing part 25 from a bottom wall (left end part) to front and rear side walls and is disposed side by side with a predetermined gap therebetween in the upward-downward direction.

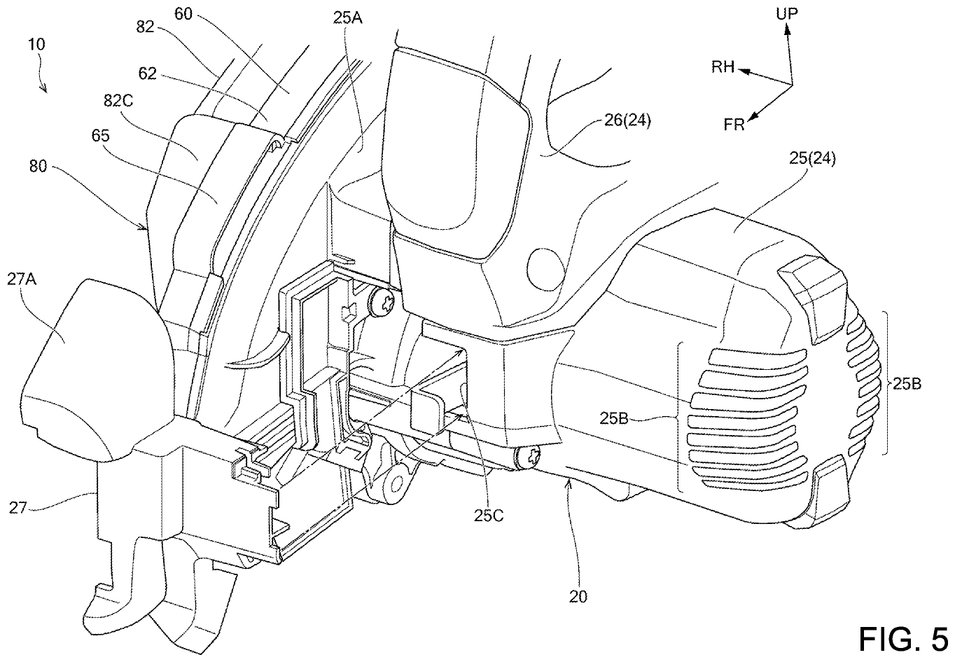

In the front wall in the right end part of the main body housing part 25, an opening part 25C (refer to FIGS. 5 and 6) is formed in a penetrating manner in a portion excluding the housing-side cover part 25A. The opening part 25C is formed to have a substantially rectangular shape when viewed from the front side and open to the front side.

The handle housing part 26 is formed to have a substantially hollow D-shape when viewed from the left side, is disposed such that the main body housing part 25 is covered from the upper side and the rear side, and is coupled to the main body housing part 25. An upper end part of the handle housing part 26 is configured to serve as a handle part 26A which is gripped by a worker, and the handle part 26A is inclined to the lower side toward the rear side in a side view.

A trigger 30 is provided in a front end side portion of the handle part 26A. The trigger 30 is configured to protrude from the handle part 26A to the lower side and be able to be subjected to a pulling operation to the upper side. In addition, in the handle part 26A, a lock button 31 for locking a pulling operation of the trigger 30 is provided on the upper side of the trigger 30. Moreover, a switch mechanism (not illustrated) is provided inside the handle part 26A. The switch mechanism has a switch (not illustrated) operated by the trigger 30. The switch is configured to be electrically connected to the control part 57 (which will be described below) and output an output signal corresponding to the operation state of the trigger 30 to the control part 57.

In addition, a rear side lower end part of the handle housing part 26 is configured to serve as a battery mounting part 26B for mounting the battery pack 59 (which will be described below). A connector (not illustrated) is provided in the battery mounting part 26B, and the connector is electrically connected to the control part 57 (which will be described below).

As illustrated in FIGS. 5 and 6, the duct 27 in its entirety is formed to have a substantially rectangular tube shape having the lateral direction as an axial direction and having the upward-downward direction as the longitudinal direction and be fixed to the main body housing part 25 such that the opening part 25C of the main body housing part 25 is blocked from the front side. The left end part of the rear wall of the duct 27 is cut out, and the inside of the duct 27 and the inside of the main body housing part 25 communicate with each other through the opening part 25C and the cutout part (refer to FIG. 6).

In addition, As also illustrated in (A) of FIG. 10, the duct 27 has a duct exit part 27A extending to the upper side, and the duct exit part 27A is disposed adjacent to an outer circumferential side portion of the housing-side cover part 25A. Moreover, the tip part of the duct exit part 27A is bent to the right side along the outer circumferential part of the housing-side cover part 25A. In addition, the duct exit part 27A is formed to have a substantially U-shape opening to the housing-side cover part 25A side when viewed in the longitudinal direction thereof

(Regarding Drive Mechanism 40)

As illustrated in FIG. 6, the drive mechanism 40 is configured to include a motor 41 and the output shaft 50. The motor 41 is accommodated inside the main body housing part 25. The motor 41 is configured to include a rotation shaft 42, a rotor 43, and a stator 44. The motor 41 is an example of a motor according to the present invention.

The rotation shaft 42 is disposed while having the lateral direction as the axial direction. Further, the left end part of the rotation shaft 42 is rotatably supported by a first motor bearing 47 fixed to the main body housing part 25, and the right side portion of the rotation shaft 42 is rotatably supported by a second motor bearing 48 fixed to the main body housing part 25. Further, the right end part of the rotation shaft 42 protrudes from the second motor bearing 48 to the right side, and a pinion gear 42A is formed in the right end part of the rotation shaft 42.

The rotor 43 is configured to be formed to have a substantially cylindrical shape having the lateral direction as the axial direction, be disposed on the outward side of the rotation shaft 42 in the radial direction, and be integrally rotatable with the rotation shaft 42. The stator 44 is formed to have a substantially cylindrical shape having the forward-rearward direction as the axial direction and is supported by the main body housing part 25 on the outward side of the rotor 43 in the radial direction. The stator 44 has a stator holder 44A, and a stator coil (not illustrated) is wound around the stator holder 44A. A motor substrate 45 is fixed to the left end part of the stator holder 44A, and the stator coil is connected to the motor substrate 45. In addition, the motor substrate 45 is electrically connected to the control part 57 (which will be described below) through a lead line (not illustrated).

In the right side portion of the rotation shaft 42, a fan 46 is provided in an integrally rotatable manner on the left side of the second motor bearing 48. The fan 46 is configured to serve as a centrifugal fan. Specifically, due to an air flow generated by the fan 46, air is caused to flow into the main body housing part 25 from the intake ports 25B of the main body housing part 25, and the air is caused to flow out into the duct 27 from the opening part 25C of the main body housing part 25. In addition, air which has flowed into the duct 27 is discharged from the duct exit part 27A.

The output shaft 50 is disposed inside the main body housing part 25 while having the lateral direction as the axial direction. Specifically, the output shaft 50 is disposed on the side below the right side end part of the rotation shaft 42 of the motor 41 (one end part in the axial direction) and on the slightly rear side with respect to the rotation shaft 42 and is rotatably supported by the main body housing part 25. An output gear (not illustrated) is provided in an integrally rotatable manner in the left end part of the output shaft 50.

Moreover, a transmission gear (deceleration mechanism, not illustrated) is provided between the rotation shaft 42 and the output shaft 50. The transmission gear is configured to serve as a two-speed gear and is meshed with the pinion gear 42A of the rotation shaft 42 and the output gear of the output shaft 50. In addition, the right end part of the output shaft 50 is configured to serve as a tool attachment part, and the tool attachment part is disposed inside the housing-side cover part 25A. In addition, the tool attachment part is formed to have a substantially cylindrical shape opening to the right side, and a male screw is formed in an inner circumferential part of the tool attachment part. Further, the central part of the saw blade 12 is extrapolated in the tool attachment part with a washer 53 therebetween, and the saw blade 12 is fixed to the right end part of the output shaft 50 by means of a bolt BL. Accordingly, during driving of the motor 41, the output shaft 50 and the saw blade 12 are constituted to rotate to one side around the output shaft 50 (a side in the arrow A direction in FIG. 1).

As illustrated in FIGS. 1 to 4, the lower part of the saw blade 12 is covered by a protective cover 55. The protective cover 55 is formed to have a substantially semicircular shape sticking out to the lower side when viewed from the right side and is formed to have a recessed shape opening to the upper side. In addition, the protective cover 55 is turnably coupled to the output shaft 50 around the output shaft 50 (refer to FIG. 6). Moreover, the protective cover 55 is biased around the output shaft 50 by a biasing spring (not illustrated) and is held at a position illustrated in FIGS. 1 to 4. Further, during cutting by the cutting tool 10, the protective cover 55 is configured to turn to the other side around the output shaft 50 against a biasing force of the biasing spring due to a machining material so that a blade part of the saw blade 12 is exposed. (B) of FIG. 10 schematically illustrates the position of the protective cover 55 during cutting. A first ventilation holes 61F are provided in a portion of a side cover wall 61 facing the right side surface of the protective cover 55 during cutting.

(Regarding Control Part 57)

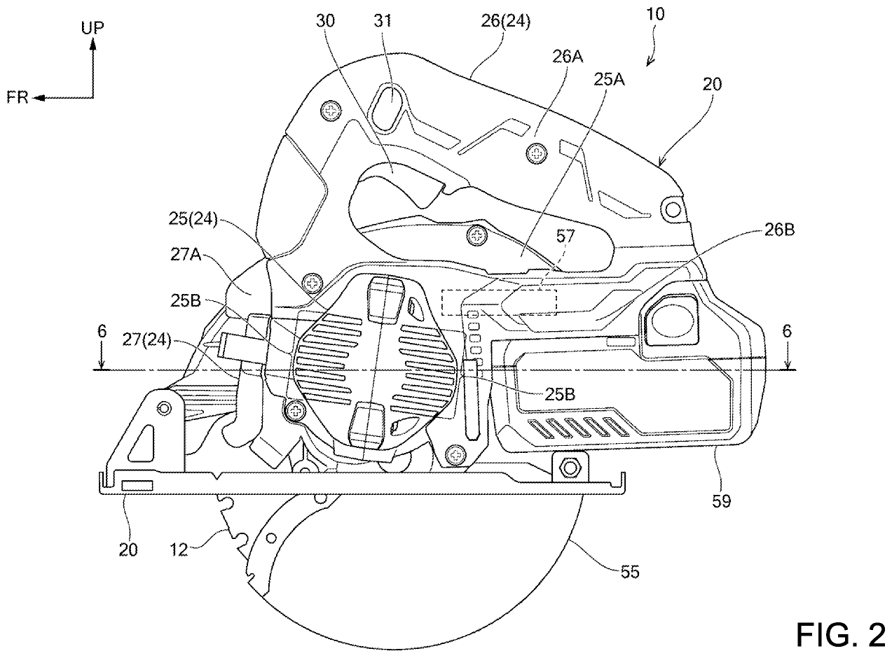

As illustrated in FIG. 2, the control part 57 is accommodated inside the front end part of the battery mounting part 26B in the handle housing part 26. The switch mechanism of the trigger 30 and the motor 41 are electrically connected to the control part 57. Accordingly, the motor 41 is driven in response to a pulling operation of the trigger 30, and the saw blade 12 rotates around the output shaft 50.

(Regarding Battery Pack 59)

The battery pack 59 is formed to be a rectangular parallelepiped. Further, the battery pack 59 is mounted in the battery mounting part 26B of the cutting tool 10 from the rear side. Moreover, the battery pack 59 has a connector (not illustrated). In a state in which the battery pack 59 is mounted, the connector is configured to be connected to the connector of the handle housing part 26 so that power is supplied from the battery pack 59 to the control part 57 (which will be described below).

(Regarding Saw Cover 60)

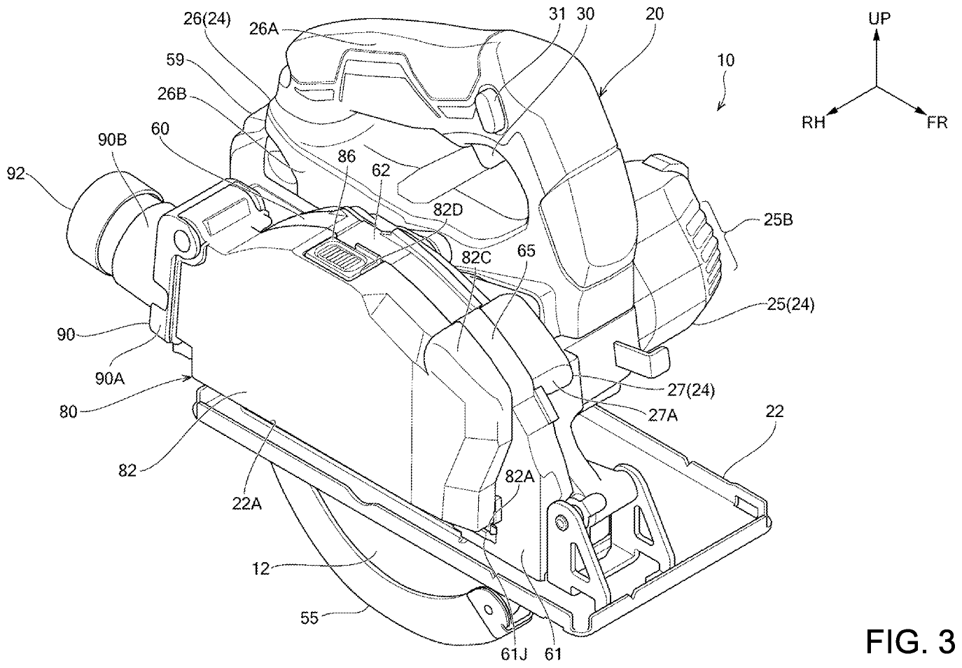

As illustrated in FIGS. 3 to 10, the saw cover 60 is constituted using a resin material. The saw cover 60 is transparent. The saw cover 60 need only be transparent to the extent that the inside can be visually recognized and need only have light transmission properties to a certain extent. The saw cover 60 is disposed adjacent to the right side of the housing-side cover part 25A of the main body housing part 25 and is configured to serve as a cover part covering the saw blade 12 from the upper side and the right side. Specifically, the saw cover 60 is configured to include the side cover wall 61 serving as a cover-side facing part with a substantially semicircular fan-like plate shape having the lateral direction as the plate thickness direction and opening to the lower side, and an outer circumferential cover wall 62 extending from an outer circumferential end part of the side cover wall 61 to the right side. Further, the side cover wall 61 configured to serve as a wall part covering the upper part of the saw blade 12 from the right side (one side of the motor 41 in the axial direction), and the outer circumferential cover wall 62 is configured to serve as a wall part covering the upper part of the saw blade 12 from the outward side in the radial direction. In addition, the outer circumferential cover wall 62 is disposed adjacent to the right side of the housing-side cover part 25A, the outer circumferential part of the side cover wall 61 is fastened to the housing-side cover part 25A, and the saw cover 60 is fixed to the main body housing part 25. Accordingly, a tool accommodation region AR (refer to FIG. 6) opening to the lower side is formed by the saw cover 60 and the housing-side cover part 25A, and the upper part of the saw blade 12 is disposed inside the tool accommodation region AR. Although the right side of the tool accommodation region AR is covered by the saw cover 60, since the saw cover 60 is transparent, the inside of the tool accommodation region AR can be visually recognized from the right side.

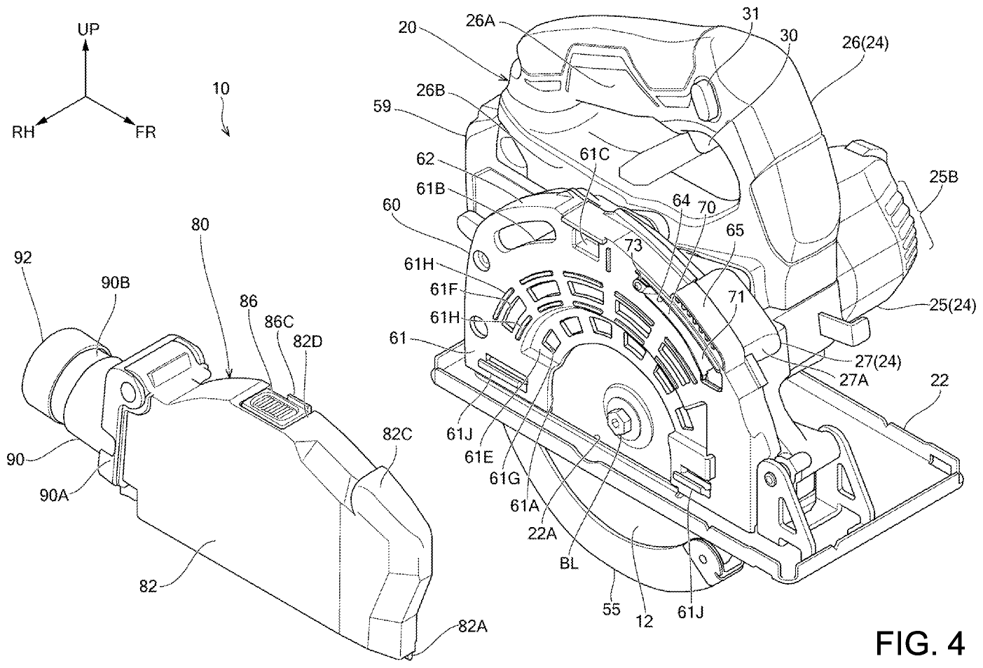

As illustrated in FIG. 4, in the lower end part of the side cover wall 61, a cover-side cutout part 61A serving as a clearance part is formed in an intermediate part in the forward-rearward direction, and the cover-side cutout part 61A is formed to have a substantially semicircular shape opening to the lower side in a side view. Further, in a state in which the dust collection box 80 (which will be described below) is detached from the tool main body 20, the bolt BL screwed to the output shaft 50 is configured to be exposed to the right side by the cover-side cutout part 61A.

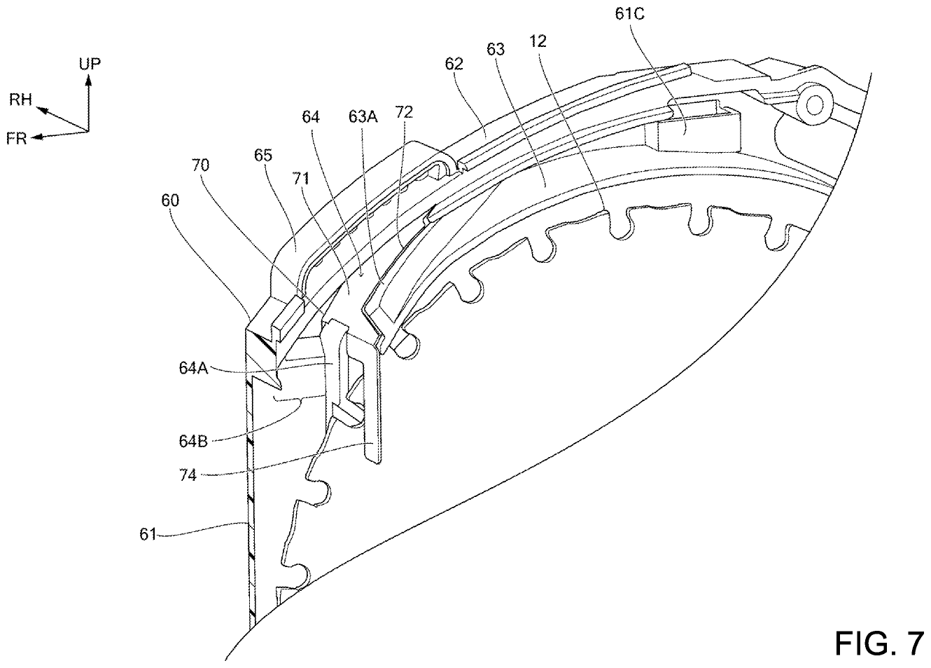

As illustrated in FIG. 7, in the upper part on the left surface of the side cover wall 61, an inward side cover wall 63 is formed between the outer circumferential cover wall 62 and the saw blade 12. The inward side cover wall 63 is formed to have a substantially elongated plate shape in a circumferential direction of the saw blade 12 while having the radial direction of the saw blade 12 as the plate thickness direction and having the forward-rearward direction as the longitudinal direction and protrudes from the side cover wall 61 to the left side. That is, the inward side cover wall 63 extends in the circumferential direction of the saw blade 12 when viewed from the left side. Accordingly, the inward side cover wall 63 is configured to cover the saw blade 12 from the upper side. More specifically, during work of the cutting tool 10, the protective cover 55 is configured to turn to the inward side of the inward side cover wall 63 in the radial direction. In addition, the saw blade 12 is configured to be rotatively driven on the inward side of the inward side cover wall 63 in the radial direction. The inward side cover wall 63 demarcates (partitions) the inside of the saw cover 60 into a driving space (first space) that is a space in which the saw blade 12 is positioned and rotatively driven and a non-driving space. That is, a region on the inward side of the inward side cover wall 63 in the radial direction is the driving space (first space), and a region on the outward side of the inward side cover wall 63 in the radial direction is the non-driving space. In addition, the inward side cover wall 63 has a portion protruding to the left side beyond the outer circumferential cover wall 62 and the saw blade 12. The inward side cover wall 63 is an example of a partitioning part according to the present invention. The tool accommodation region AR is the driving space or the first space according to the present invention. The saw blade 12 is positioned in the tool accommodation region AR (first space). The protective cover 55 is positioned in the tool accommodation region AR (first space).

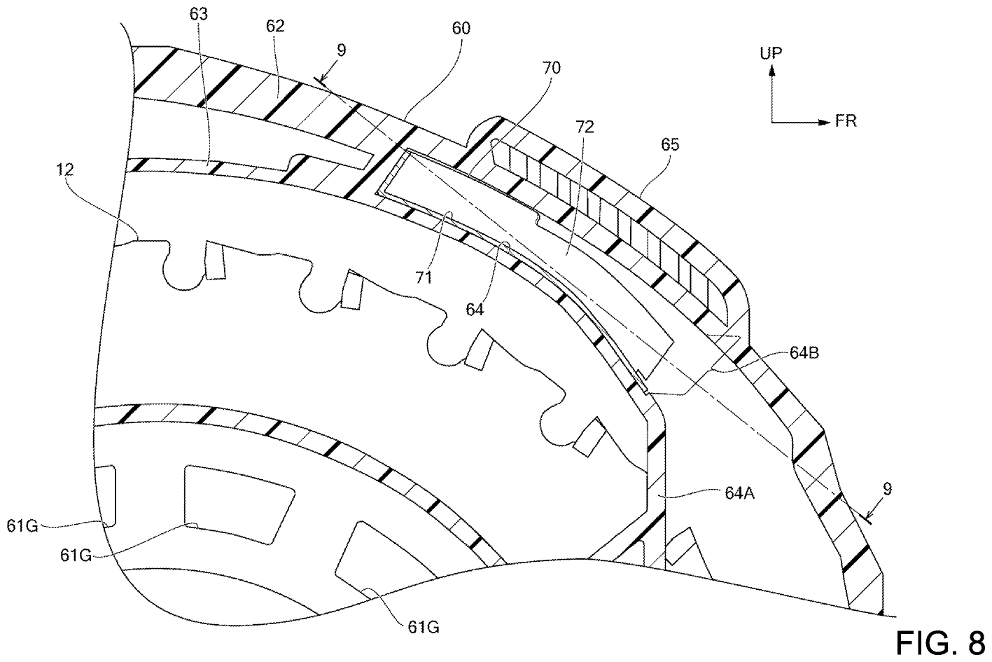

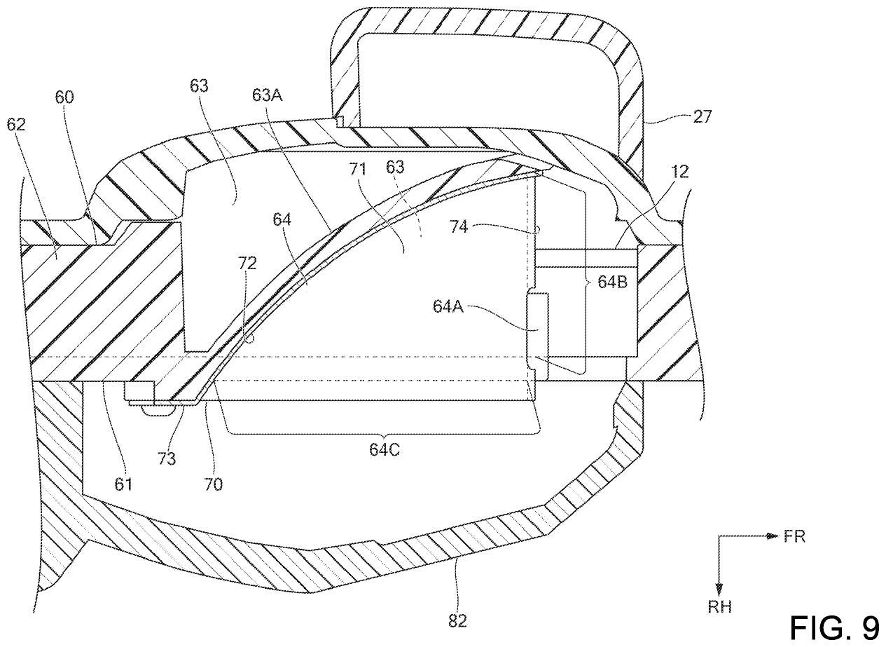

As also illustrated in FIG. 8 to (A) of FIG. 10, an inclined wall 63A serving as a guide wall is formed on the upper surface of the front end part of the inward side cover wall 63. The inclined wall 63A is inclined to the right side in a curved shape from the front left end part of the inward side cover wall 63 toward the rear end side of the inward side cover wall 63 (a side of the saw blade 12 in a rotation direction and a side in the arrow A direction in FIG. 1). Moreover, a portion (right side portion) of the inclined wall 63A is disposed between the inward side cover wall 63 and the outer circumferential cover wall 62 and couples both to each other. Accordingly, a chip discharge passage section 64 serving as a discharge passage section surrounded by the inward side cover wall 63, the inclined wall 63A, and the outer circumferential cover wall 62 is formed in the saw cover 60. The inclined wall 63A provided in the inward side cover wall 63 demarcates the non-driving space (a space on the outward side of the inward side cover wall 63 in the radial direction) into a passage space through which chips pass (chip discharge passage section 64) and a non-passage space through which chips do not pass. The inclined wall 63A is an example of a demarcation part according to the present invention. In the present embodiment, in order to divide the space inside the chip discharge passage section 64, a portion of the housing-side cover part 25A (main body housing part 25) is utilized as a side wall. That is, the chip discharge passage section 64 is formed by a portion of the saw cover 60 and a portion of the main body housing part 25. The space inside the chip discharge passage section 64 may be divided by only the saw cover 60. However, in order to realize the curved shape on the left side surface of the chip discharge passage section 64 as illustrated in FIG. 9, that is, a curved shape from the front to the rear and a complicated shape which is curved such that it bulges to the outward side (left side) and returns to the inward side (right side), it is effective to form the chip discharge passage section 64 with a plurality of components. The chip discharge passage section 64 is an example of a passage space or a second space through which chips (machining chips) pass.

In addition, a cover-side entrance guide 64A (refer to FIG. 7) is formed in the front end right side part of the inward side cover wall 63 constituting the chip discharge passage section 64. The cover-side entrance guide 64A extends from the front end part of the inward side cover wall 63 to the lower side, is connected to the left surface of the side cover wall 61, and is disposed on the right side of the outer circumferential part on the front end side in the saw blade 12. Further, the space portion between the front end part of the inward side cover wall 63 in the forward-rearward direction and the outer circumferential cover wall 62 is configured to serve as an entrance part 64B of the chip discharge passage section 64 (refer to FIGS. 7 to 9). Accordingly, the entrance part 64B opens to the lower side (saw blade 12 side) by the cover-side entrance guide 64A, and the chip discharge passage section 64 and the tool accommodation region AR communicate with each other through the entrance part 64B. The entrance part 64B is positioned on the outward side of the outer diameter of the saw blade 12 having a circular shape. The entrance part 64B is a portion of the passage space through which chips (machining chips) pass.

Moreover, the chip discharge passage section 64 opens to the right side. Namely, a hole part for opening the chip discharge passage section 64 is formed in the side cover wall 61, and the hole part is configured to serve as an exit part 64C (refer to FIG. 9 and (A) of FIG. 10). Accordingly, it is constituted such that when chips generated during cutting with respect to a machining material are whirled up to the upper side by the saw blade 12 inside the tool accommodation region AR, the whirled-up chips are introduced into the chip discharge passage section 64 from the entrance part 64B and discharged to the right side from the exit part 64C of the chip discharge passage section 64.

On the upper surface of the outer circumferential cover wall 62, a cover-side intake part 65 is formed on the side above the chip discharge passage section 64 and at a position corresponding to the tip part of the duct exit part 27A of the duct 27. Corresponding to the duct exit part 27A, the cover-side intake part 65 is formed to have a substantially U-shape opening to the lower side in a side view, and both end parts of the cover-side intake part 65 in the longitudinal direction are connected to the outer circumferential cover wall 62. Further, the tip part of the duct exit part 27A is disposed adjacent to the left side of the cover-side intake part 65, and the inside of the duct exit part 27A and the inside of the cover-side intake part 65 communicate with each other.

As illustrated in FIG. 4, a cover-side exhaust outlet 61B is formed in a penetrating manner in the upper end part of the rear part of the side cover wall 61. The cover-side exhaust outlet 61B is disposed between the inward side cover wall 63 and the outer circumferential cover wall 62 in the radial direction of the side cover wall 61 and is formed to have a long hole shape in the circumferential direction of the side cover wall 61 in a side view.

In the upper end part of the side cover wall 61, a button insertion part 61C into which a portion of an attachment/detachment button 86 of the dust collection box 80 (which will be described below) is inserted is formed between the chip discharge passage section 64 and the cover-side exhaust outlet 61B. The button insertion part 61C is formed to have a recessed shape opening to the right side, and a first fixing hook 61D (refer to (B) of FIG. 10) protruding to the lower side is formed in the edge portion on the side above the button insertion part 61C.

A narrow part 61E which is lowered to the left side by one step is formed in a portion of the side cover wall 61 on the inward side in the radial direction. The narrow part 61E is formed to have a semicircular arc shape extending in the circumferential direction of the side cover wall 61 in a side view. In addition, in the side cover wall 61, a plurality of (five locations in the present embodiment) first ventilation holes 61F serving as ventilation holes is formed in a penetrating manner (in FIG. 4, for the sake of convenience, the reference sign is applied to only the first ventilation hole 61F on the rear side) on the outward side of the narrow part 61E in the radial direction. The first ventilation holes 61F are formed to have a substantially fan shape in a side view and are disposed side by side in the circumferential direction of the side cover wall 61.

Moreover, in the narrow part 61E of the side cover wall 61, a plurality of (five locations in the present embodiment) second ventilation holes 61G serving as ventilation holes is formed in a penetrating manner (in FIG. 4, for the sake of convenience, the reference sign is applied to only the second ventilation hole 61G on the rear side). Similar to the first ventilation holes 61F, the second ventilation holes 61G are formed to have a substantially fan shape in a side view and are disposed side by side in the circumferential direction of the side cover wall 61. In addition, the second ventilation holes 61G are disposed on the inward side of the side cover wall 61 in the radial direction respectively with respect to the first ventilation holes 61F.

In addition, in the side cover wall 61, abutment ribs 61H are formed (in FIG. 4, for the sake of convenience, the reference sign is applied to only a pair of abutment ribs 61H on the rear side) on the outward side of the side cover wall 61 in the radial direction and the inward side thereof in the radial direction respectively with respect to the first ventilation holes 61F. That is, the abutment ribs 61H are formed at ten locations in the side cover wall 61. The abutment ribs 61H extend in the circumferential direction of the narrow part 61E in a side view and protrude to the right side.

In addition, a pair of front and rear second fixing hooks 61J for fixing the dust collection box 80 (which will be described below) is formed in the lower end part of the side cover wall 61. The second fixing hooks 61J are formed to have a substantially L-shape when viewed from the front side, protrude from the side cover wall 61 to the right side, and extend in the forward-rearward direction.

(Regarding Guard Member 70)

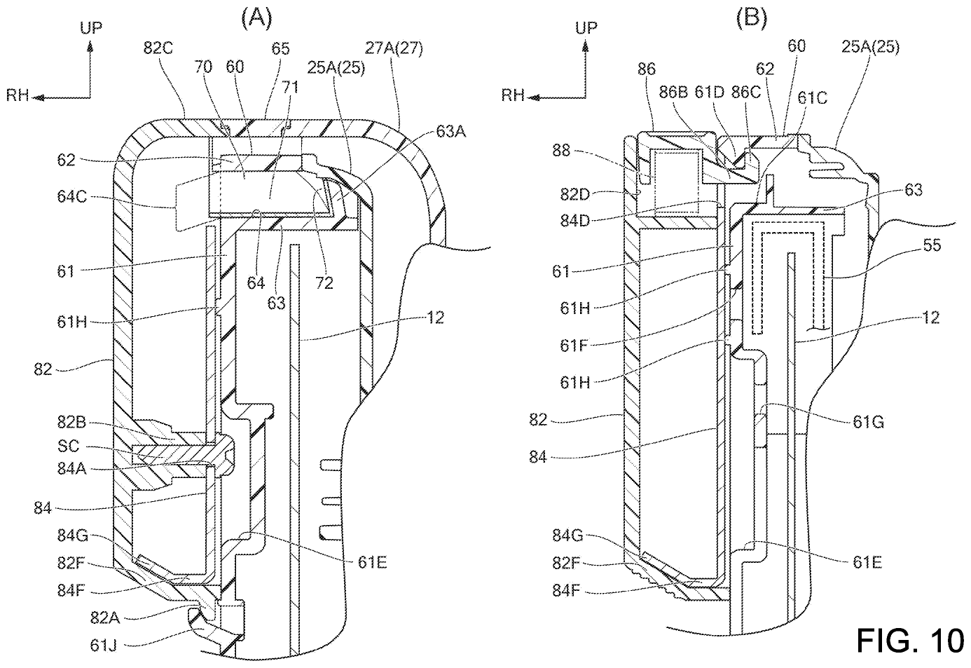

As illustrated in FIG. 4, FIG. 7 to (A) of FIG. 10, and FIG. 11, the guard member 70 is disposed inside the chip discharge passage section 64 of the saw cover 60 and is configured to serve as a member for protecting the bottom wall of the chip discharge passage section 64 (a portion on the upper surface of the inward side cover wall 63). The guard member 70 is a metal, and it is aluminum in the present embodiment. The guard member 70 has a guard main body 71, and the guard main body 71 is formed to have a plate shape disposed parallel to the inward side cover wall 63. That is, in a side view, the guard main body 71 is curved in a curved shape in the longitudinal direction of the inward side cover wall 63. In addition, the guard main body 71 is formed to have a substantially triangular shape such that a shape similar to the bottom surface of the chip discharge passage section 64 is formed when viewed in the plate thickness direction of the inward side cover wall 63 and is disposed adjacent to the upper side on the bottom surface of the chip discharge passage section 64. That is, the right end part of the guard main body 71 extends in a straight line shape in the forward-rearward direction, and the left end part of the guard main body 71 is inclined to the right side in a curved shape toward the rear side. The guard member 70 is an example of a protective member according to the present invention.

In addition, the guard main body 71 is configured to cover the bottom wall of the chip discharge passage section 64 (passage space) from the upper side throughout the chip discharge passage section 64 from the entrance part 64B to the exit part 64C. More specifically, the right end part of the guard main body 71 protrudes from the exit part 64C of the chip discharge passage section 64 to the left side. That is, the guard main body 71 protrudes from the side cover wall 61 of the saw cover 60 to the left side (the dust collection box 80 side, which will be described below) (refer to (A) of FIG. 10). In other words, a portion of the inward side cover wall 63 (partitioning part) exposed to the inside of the passage space (second space) through which chips move and pass is covered by the guard main body 71 that is a protective member.

A guard-side inclined wall 72 serving as a guide guard bent to the upper side is single-structurally formed in the left end part of the guard main body 71. That is, corresponding to the inclined wall 63A of the saw cover 60, the guard-side inclined wall 72 is inclined to the right side in a curved shape toward the rear side. In other words, the guard-side inclined wall 72 is inclined to the exit part 64C side of the chip discharge passage section 64 toward the side of the saw blade 12 in the rotation direction. Accordingly, it is constituted such that chips which have flowed into the chip discharge passage section 64 are guided to the exit part 64C side of the chip discharge passage section 64 by the guard-side inclined wall 72.

The rear end part of the guard-side inclined wall 72 is configured to serve as a guard fixing part 73, and the guard fixing part 73 is bent to the rear side and protrudes to the rear side beyond the guard main body 71. Further, the guard fixing part 73 is disposed on the left side of the rear side circumferential edge part in the exit part 64C of the chip discharge passage section 64 and is fixed to the side cover wall 61 by welding. The guard fixing part 73 may be fixed to the exit part 64C using a fixing tool such as a screw. As above, the guard member 70 is configured to guard and protect the bottom wall of the chip discharge passage section 64 in the saw cover 60 and the inclined wall 63A from the inward side.

In addition, a guard-side entrance guide 74 serving as an entrance guide part bent to the lower side is formed in the right side portion in the front end part of the guard main body 71. The guard-side entrance guide 74 is disposed on the left side of the outer circumferential part on the front end side of the saw blade 12. More specifically, the cover-side entrance guide 64A of the saw cover 60 and the guard-side entrance guide 74 are disposed such that the outer circumferential part on the front end side of the saw blade 12 is sandwiched therebetween in the lateral direction (refer to FIG. 7). Some of chips which tend to flow to the rear at a position below the front end part of the guard main body 71 abut the front surfaces of the cover-side entrance guide 64A and the guard-side entrance guide 74, and while movement thereof is limited, they are sent to the guard main body 71 side by air generated due to rotation of the saw blade 12. In this manner, the cover-side entrance guide 64A and the guard-side entrance guide 74 have a function of curbing flowing of chips to the rear beyond the front end part of the guard main body 71, that is, curbing separation of chips to the rear beyond the entrance part 64B and improving the dust collection efficiency of chips.

(Regarding Dust Collection Box 80)

As illustrated in FIGS. 3 to 6, and 12, the dust collection box 80 is detachably attached to the saw cover 60 of the tool main body 20 and is disposed on the right side of the saw cover 60. Further, it is constituted such that chips discharged from the chip discharge passage section 64 of the saw cover 60 are stored in the dust collection box 80. The dust collection box 80 is configured to include an outer case 82 (right side portion) serving as a second case, an inner case 84 (left side portion) serving as a box-side facing part and a first case, the attachment/detachment button 86, and a dust collector connection part 90. That is, the dust collection box 80 has a first wall part (inner case 84) on the saw blade 12 side (left side) and has a second wall part (outer case 82) on a side opposite to the saw blade 12 (right side).

(Regarding Outer Case 82)

The outer case 82 is constituted using a resin material. In addition, the outer case 82 is transparent. The outer case 82 need only be transparent to the extent that the inside of the dust collection box 80 can be visually recognized and need only be formed of a material having permeable properties to the extent that the inside can be visually recognized. The outer case 82 is formed to have a substantially rectangular box shape opening to the left side. In the left end part of the lower wall of the outer case 82, a pair of front and rear box-side engagement hooks 82A is formed at positions corresponding to the second fixing hooks 61J of the saw cover 60. The box-side engagement hooks 82A are formed to have a rib shape having the lateral direction as a thickness direction and extending in the forward-rearward direction and protrude from the outer case 82 to the lower side. Further, the box-side engagement hooks 82A are thrust between the second fixing hooks 61J of the saw cover 60 and the side cover wall 61 from the upper side, the second fixing hooks 61J and the box-side engagement hooks 82A engage with each other in the lateral direction, and therefore the lower end part of the outer case 82 is attached to the saw cover 60 (refer to (A) of FIG. 10). In addition, the upper end part of the outer case 82 is attached to the saw cover 60 by the attachment/detachment button 86 (which will be described below). Moreover, in a state in which the outer case 82 is attached to the saw cover 60, the upper surface of the outer case 82 is curved in a substantially arc shape in a side view such that it becomes flush with the upper surface of the saw cover 60.

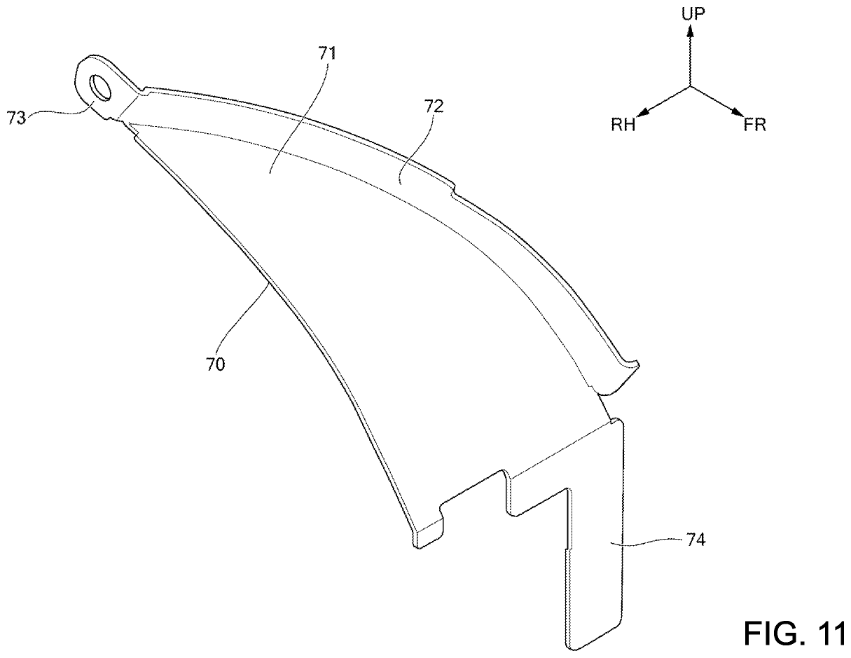

As illustrated in FIG. 12, a plurality of (three locations in the present embodiment) fixing bosses 82B for fixing the inner case 84 (which will be described below) is formed in the right wall of the outer case 82. The fixing bosses 82B are formed to have a substantially cylindrical shape having the lateral direction as the axial direction and protrude from the right wall of the outer case 82 to the left side. In addition, the fixing bosses 82B are respectively formed in the front end part, the rear end part, and the upper end part of the outer case 82.

In the rear end part of the upper wall of the outer case 82, a box-side intake part 82C is formed at a position corresponding to the cover-side intake part 65 of the saw cover 60. The box-side intake part 82C rises to the upper side with respect to the upper wall of the outer case 82 and is formed to have a shape corresponding to the cover-side intake part 65. Further, the right end part of the cover-side intake part 65 and the left end part of the box-side intake part 82C are connected to each other. Accordingly, the inside of the main body housing part 25 and the inside of the dust collection box 80 communicate with each other through the duct 27 and the cover-side intake part 65 of the saw cover 60 (refer to (A) of FIG. 10).

In the upper wall of the outer case 82, a button accommodation part 82D for accommodating the attachment/detachment button 86 (which will be described below) is formed in the intermediate part in the forward-rearward direction. The button accommodation part 82D is formed to have a recessed shape opening to the upper side and the left side and is disposed on the right side of the button insertion part 61C of the saw cover 60. Engagement grooves 82E are respectively formed on the front and rear inner circumferential surfaces of the button accommodation part 82D in the intermediate part in the upward-downward direction. The engagement grooves 82E extend in the lateral direction, and the left end parts of the engagement grooves 82E open to the left side.

A case inclination part 82F is formed at a corner part between the lower wall and the right wall of the outer case 82. The case inclination part 82F is inclined to the upper side toward the right side when viewed from the front side (refer to (A) of FIG. 10 and (B) of FIG. 10). An uneven shape is formed on the outer surface of the case inclination part 82F so that it is easy to hold and operate the dust collection box 80.

A mounting part 82G for mounting the dust collector connection part 90 (which will be described below) is formed in the rear end part of the outer case 82. The mounting part 82G is formed to have a substantially rectangular tube shape having the forward-rearward direction as the axial direction and having the upward-downward direction as the longitudinal direction and protrudes from the outer case 82 to the rear side. In addition, the left part of the mounting part 82G protrudes to the left side beyond the outer case 82. Moreover, a discharge hole 82H allowing the inside of the outer case 82 and the inside of the mounting part 82G to communicate with each other is formed in a penetrating manner in the rear wall of the outer case 82. That is, the dust collection box 80 has the first wall part (inner case 84) on the saw blade 12 side (left side) and has the second wall part (outer case 82) on a side opposite to the saw blade 12 (right side). However, a portion which is not covered by these wall parts becomes the discharge hole 82H, and the discharge hole 82H is blocked by the dust collector connection part 90. As described below, the inside of the dust collection box 80 functions as a space for collecting chips. That is, the dust collection box 80 has a chip accommodation part 80A for accommodating chips. The inside of the dust collection box 80 (chip accommodation part 80A) is an accommodation space in which chips are collected and is an example of a space through which chips pass or are collected (second space).

(Regarding Inner Case 84)

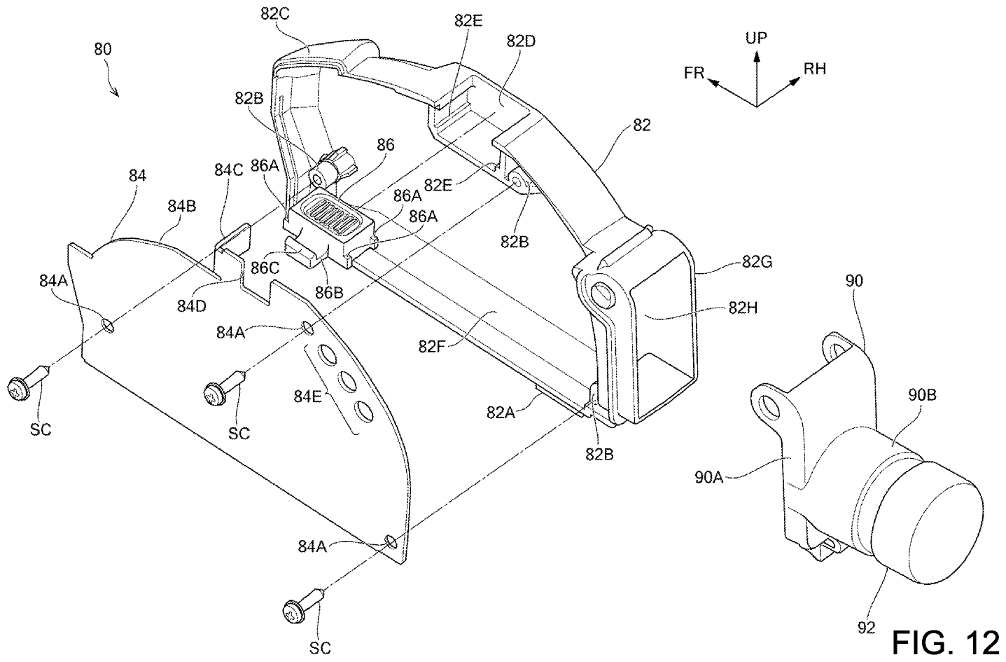

As illustrated in FIGS. 12 and 13, the inner case 84 is constituted using a metal plate material. The inner case 84 is disposed while having the lateral direction as the plate thickness direction and is formed such that the external shape of the inner case 84 forms a shape similar to the external shape of the outer case 82 when viewed from the right side. That is, the upper end part of the inner case 84 is curved in an arc shape sticking out to the upper side. Fixing holes 84A are formed in a penetrating manner in the inner case 84 at positions corresponding to the fixing bosses 82B of the outer case 82. Further, fixing screws SC are inserted into the fixing holes 84A from the left side and are screwed to the fixing bosses 82B so that the inner case 84 is fixed to the outer case 82. In addition, in a state in which the inner case 84 is fixed to the outer case 82, the inner case 84 is disposed on the inward side of the opening part of the outer case 82, and the opening part of the outer case 82 is blocked by the inner case 84.

Further, in a state in which the dust collection box 80 is attached to the tool main body 20, the inner case 84 is configured to be disposed adjacent to the right side of the abutment ribs 61H of the saw cover 60 (refer to (A) of FIG. 10 and (B) of FIG. 10). That is, the inner case 84 is disposed with a predetermined gap therebetween on the right side of the side cover wall 61 of the saw cover 60, and the side cover wall 61 and the inner case 84 face each other in the lateral direction.

A box entrance section 84B is formed in the outer circumferential part on the side above the front part of the inner case 84. The box entrance section 84B is cut out such that it is lowered to the inward side in the radial direction from the outer circumferential part of the inner case 84 by one step when viewed from the right side, and the dust collection box 80 and the chip discharge passage section 64 of the saw cover 60 communicate with each other through the box entrance section 84B. Accordingly, it is constituted such that chips discharged from the exit part 64C of the chip discharge passage section 64 enter the inside of (are introduced into) the dust collection box 80.

In the upper end part of the inner case 84, a stopper wall 84C serving as a stopper part is formed on the side above the rear end part of the box entrance section 84B. The stopper wall 84C is bent to the right side, is formed to have a substantially rectangular plate shape having the forward-rearward direction as the plate thickness direction, and is disposed on one side of the saw blade 12 in the circumferential direction (a side in the rotation direction) with respect to the chip discharge passage section 64 in a side view. Accordingly, it is constituted such that chips discharged to the right side and the side of the saw blade 12 in the rotation direction from the exit part 64C of the chip discharge passage section 64 collide with the stopper wall 84C.

In the upper end part of the inner case 84, a button insertion groove 84D for inserting the attachment/detachment button 86 (which will be described below) therethrough is formed on the rear side of the stopper wall 84C. The button insertion groove 84D is formed to have a recessed shape opening to the upper side and is disposed on the right side of the button insertion part 61C of the saw cover 60.

In addition, in the outer circumferential part on the side above the rear part of the inner case 84, a plurality of (three locations in the present embodiment) box-side exhaust outlets 84E is formed in a penetrating manner. The box-side exhaust outlets 84E are disposed on the right side of the cover-side exhaust outlet 61B of the saw cover 60. Accordingly, the inside of the dust collection box 80 and the tool accommodation region AR communicate with each other through the cover-side exhaust outlet 61B and the box-side exhaust outlets 84E. Further, in the present embodiment, during operation of the cutting tool 10, the following air flow is generated due to rotation of the fan 46 of the motor 41. That is, it is constituted such that air is caused to flow into the duct 27 from the intake ports 25B of the main body housing part 25, air inside the duct 27 is caused to flow into the dust collection box 80 via the duct exit part 27A and the cover-side intake part 65 of the saw cover 60, and air inside the dust collection box 80 is caused to be discharged into the tool accommodation region AR via the box-side exhaust outlets 84E and the cover-side exhaust outlet 61B. Accordingly, the inner case 84 is configured to be cooled by an air flow generated due to rotation of the fan 46.

As also illustrated in (A) of FIG. 10 and (B) of FIG. 10, a box bottom part 84F serving as a cover part bent to the right side is formed in the lower end part of the inner case 84, and the box bottom part 84F extends in the forward-rearward direction and is disposed adjacent to the upper side of the lower wall of the outer case 82. Accordingly, the box bottom part 84F constitutes the bottom part inside the dust collection box 80. In addition, an inclined part 84G corresponding to the case inclination part 82F of the outer case 82 is formed in the tip part of the box bottom part 84F. The inclined part 84G is inclined to the upper side toward the right side when viewed from the front side and is disposed adjacent to the upper side of the case inclination part 82F of the outer case 82. The box bottom part 84F is made by bending a portion of the inner case 84 and forms a single-structurally-formed structure with the inner case 84. However, while it is structured separately from the inner case 84, they may be configured to be connected to each other inside the dust collection box 80. The box bottom part 84F is a portion extending from the inner case 84 and becoming a portion of the bottom part inside the dust collection box 80.

(Regarding Attachment/Detachment Button 86)

As illustrated in (B) of FIG. 10 and FIG. 12, the attachment/detachment button 86 is formed to have a substantially rectangular box shape opening to the lower side and is disposed inside the button accommodation part 82D of the outer case 82. A pair of left and right engagement projections 86A is respectively formed in the lower end parts of the front and rear surfaces of the attachment/detachment button 86. That is, in the attachment/detachment button 86, the engagement projections 86A are formed at four locations. Further, the engagement projections 86A are inserted into the engagement grooves 82E of the outer case 82. Since a portion on the left side surface of the attachment/detachment button 86 has a positional relationship facing a portion on the right side surface of the inner case 84, movement of the attachment/detachment button 86 in the leftward direction is restricted by the inner case 84.

In addition, a button spring 88 (refer to (B) of FIG. 10) is disposed inside the attachment/detachment button 86. The button spring 88 is configured to serve as a compression coil spring. The upper end part of the button spring 88 is interlocked with the upper wall of the attachment/detachment button 86, and the lower end part of the button spring 88 is interlocked with the lower wall of the button accommodation part 82D. Accordingly, the attachment/detachment button 86 is biased to the upper side by the button spring 88, and the engagement projections 86A abut the upper surfaces of the engagement grooves 82E. Therefore, the attachment/detachment button 86 is configured to be able to be subjected to a pressurization operation to the lower side.

In addition, a button engagement piece 86B is formed in the attachment/detachment button 86. The button engagement piece 86B protrudes from the lower end part of the attachment/detachment button 86 to the left side while having the upward-downward direction as the plate thickness direction. Specifically, the button engagement piece 86B is inserted through the inside of the button insertion groove 84D of the inner case 84, and the tip part of the button engagement piece 86B is inserted into the button insertion part 61C of the saw cover 60. The width measurement of the button engagement piece 86B (measurement in the forward-rearward direction) is set to be slightly smaller than the width measurement of the button insertion groove 84D. Accordingly, the position of the attachment/detachment button 86 in the forward-rearward direction is configured to be determined based on the button insertion groove 84D of the inner case 84. That is, movement of the attachment/detachment button 86 in the forward-rearward direction and the leftward direction is restricted by the inner case 84.

Moreover, an engaged hook part 86C protruding to the upper side is formed in the tip part of the button engagement piece 86B. The engaged hook part 86C is disposed adjacent to the left side of the first fixing hook 61D of the saw cover 60, and the engaged hook part 86C and the first fixing hook 61D engage with each other in the lateral direction. Accordingly, movement of the upper end part of the dust collection box 80 to the right side is limited. Further, the engaged state between the engaged hook part 86C and the first fixing hook 61D is canceled by pressurizing the attachment/detachment button 86 to the lower side. Accordingly, the dust collection box 80 is configured to be able to be detached from the tool main body 20.

(Regarding Dust Collector Connection Part 90)

As illustrated in FIGS. 1, 3, 4, 6, and 12, the dust collector connection part 90 is configured to include a mounted part 90A constituting the front part of the dust collector connection part 90, and a connection tube part 90B constituting the rear part of the dust collector connection part 90. The mounted part 90A is formed to have a substantially rectangular box shape opening to the front side. Further, the mounted part 90A is coupled to the mounting part 82G such that the mounting part 82G of the outer case 82 is blocked. Specifically, the upper end part of the mounted part 90A is rotatably coupled to the upper end part of the mounting part 82G of the outer case 82 while having the lateral direction as the axial direction.

The connection tube part 90B is formed to have a substantially cylindrical shape having the forward-rearward direction as the axial direction and protrudes from the mounted part 90A to the rear side. In addition, the inside of the connection tube part 90B and the inside of the mounted part 90A communicate with each other. Further, a hose of a dust collector (not illustrated) is configured to be connected to the rear end part of the connection tube part 90B. Accordingly, the dust collector is configured to suction chips in the dust collection box 80 and discharge the chips to the outside of the dust collection box 80. When the hose of the dust collector is not connected to the connection tube part 90B, a cap 92 having a bottomed cylindrical shape is attached to the connection tube part 90B.

(Operational Effects)

Next, operations and effects of the cutting tool 10 of the present embodiment will be described.

When the cutting tool 10 constituted as described above is used, the base 22 is placed on a machining material, and the trigger 30 is subjected to a pulling operation. Accordingly, the motor 41 is driven, a driving force of the motor 41 is transmitted to the saw blade 12, and the saw blade 12 rotates to one side around the output shaft 50. Further, cutting is performed with respect to a machining material by moving the cutting tool 10 to the front side.

In addition, during cutting with respect to a machining material, chips generated by cutting are whirled up to the upper side due to a rotation force of the saw blade 12. Specifically, chips are whirled up to the upper side from the front end outer circumferential part of the saw blade 12 and move to the side of the saw blade 12 in the rotation direction along the outer circumferential part of the housing-side cover part 25A and the outer circumferential cover wall 62 of the saw cover 60. For this reason, whirled-up chips are guided by the cover-side entrance guide 64A of the saw cover 60 and the guard-side entrance guide 74 of the guard member 70 and are inserted into the chip discharge passage section 64 from the entrance part 64B of the saw cover 60. Chips inserted into the chip discharge passage section 64 are guided to the exit part 64C side of the chip discharge passage section 64 by the guard-side inclined wall 72 of the guard member 70 and are discharged from the exit part 64C.

In addition, during discharging of chips from the exit part 64C, chips are discharged such that they burst out to the right side from the exit part 64C and one side of the saw blade 12 in the rotation direction due to a rotation force of the saw blade 12. For this reason, chips discharged from the exit part 64C collide with the stopper wall 84C of the inner case 84 in the dust collection box 80, and the collided chips fall down inside the dust collection box 80. Accordingly, chips are stored inside the dust collection box 80.

Incidentally, when a machining material is a metal material, chips which are metal pieces having a relatively high temperature pass through the inside of the chip discharge passage section 64 of the saw cover 60 and are discharged into the dust collection box 80 from the chip discharge passage section 64. Further, when chips pass through the inside of the chip discharge passage section 64 in the saw cover 60, the chips pass through to the exit part 64C from the entrance part 64B of the chip discharge passage section 64 while abutting the bottom surface of the chip discharge passage section 64. For this reason, there is a likelihood that the bottom wall of the chip discharge passage section 64 (upper surface of the inward side cover wall 63) will be scraped and deformed due to vigorous contact of metal pieces or the bottom wall of the chip discharge passage section 64 will be thermally deformed due to contact of high-temperature chips. Further, there is concern that the side surface on the saw blade 12 side in the bottom wall of the chip discharge passage section 64 (lower surface of the inward side cover wall 63) may also be deformed due to continuous contact of chips and rotation of the saw blade 12 may be affected. In short, there is concern that movement of chips moving in the second space may be hindered or movement of the saw blade 12 and the protective cover 55 positioned in the first space may be affected due to deformation caused by chips in the partitioning part (inward side cover wall 63) positioned between the first space and the second space described above.

Here, the metal guard member 70 is provided inside the chip discharge passage section 64, and the bottom wall on the saw blade 12 side in the chip discharge passage section 64 is covered by the guard member 70. That is, the bottom surface in the chip discharge passage section 64 (upper surface of the inward side cover wall 63) is protected (guarded) by the metal guard member 70. The guard member 70 is provided such that it is exposed in the chip discharge passage section 64. For this reason, a situation in which high-temperature metal pieces directly abut (arrive at) the bottom wall of the chip discharge passage section 64 can be curbed by the guard member 70. Accordingly, deformation of the chip discharge passage section 64 when chips pass through the inside of the chip discharge passage section 64 can be curbed. Therefore, durability of the saw cover 60 can be improved, and workability of the cutting tool 10 can be improved. In the present embodiment, the guard member 70 is made of aluminum, but a different metal having high durability (wear resistance, impact resistance, and heat resistance) such as iron may be adopted. The guard member 70 may not be made of a metal and need only be harder (higher wear resistance or impact resistance) or have higher heat resistance (melting point) than an inward side cover member 63 serving as a partitioning part or need only have properties satisfying both. For example, the guard member 70 may be a member obtained by machining carbon fibers or may be a member or a portion formed of a resin material reinforced by including carbon fibers.

In addition, the chip discharge passage section 64 is disposed on the outward side of the saw blade 12 in the radial direction, and the protective cover 55 turns between the saw blade 12 and the chip discharge passage section 64 (inside the first space) during work of the cutting tool 10. Further, as described above, deformation of the wall part of the chip discharge passage section 64 on the saw blade 12 side (inward side cover wall 63) can be curbed by the guard member 70. Accordingly, inhibition of turning of the protective cover 55 due to deformation of the bottom wall of the chip discharge passage section 64 can be curbed. Therefore, workability of the cutting tool 10 can be favorably maintained.

In addition, the dust collection box 80 is detachably attached to the right side of the saw cover 60, and the box entrance section 84B for causing the inside of the chip discharge passage section 64 and the inside of the dust collection box 80 to communicate with each other is formed in the dust collection box 80. For this reason, chips discharged from the exit part 64C of the chip discharge passage section 64 can be stored inside the dust collection box 80 (chip accommodation part 80A).

In addition, the guard main body 71 of the guard member 70 covers the bottom wall of the chip discharge passage section 64 throughout the exit part 64C from the entrance part 64B of the chip discharge passage section 64. Accordingly, deformation of a part on the exit part 64C side of the chip discharge passage section 64 can be curbed. That is, deformation of a part on the dust collection box 80 side in the chip discharge passage section 64 can be curbed. Accordingly, inhibition of attachment of the saw cover 60 to the dust collection box 80 due to deformation of the chip discharge passage section 64 can be curbed. In addition, a portion of the guard main body 71 extends to the position of the inner case 84 such that it goes over the right end part of the bottom wall of the chip discharge passage section 64 (side wall on the saw blade 12 side), that is, the exit part 64C (refer to FIGS. 9 and 10). Accordingly, invasion of chips discharged from the exit part 64C with respect to the gap made by the ribs 61H between the inner case 84 and the side cover wall 61 is curbed.

In addition, the guard-side inclined wall 72 is provided in the guard member 70, and the guard-side inclined wall 72 is inclined to the right side in a curved shape toward the side of the saw blade 12 in the rotation direction. In other words, the guard-side inclined wall 72 is inclined to the exit part 64C side of the chip discharge passage section 64 toward the side of the saw blade 12 in the rotation direction. Accordingly, chips inserted into the chip discharge passage section 64 can be guided to the exit part 64C side while durability is secured by the guard-side inclined wall 72. Therefore, chips can be favorably discharged from the chip discharge passage section 64.

In addition, the cover-side entrance guide 64A extending from the front end part of the chip discharge passage section 64 to the lower side is formed in the saw cover 60, and the guard-side entrance guide 74 extending from the front end part of the guard main body 71 to the lower side is formed in the guard member 70. Further, the outer circumferential part of the saw blade 12 is sandwiched by the cover-side entrance guide 64A and the guard-side entrance guide 74 in the lateral direction. Accordingly, during cutting of a machining material, chips which have been whirled up by the saw blade 12 can be favorably introduced into the chip discharge passage section 64 by the cover-side entrance guide 64A and the guard-side entrance guide 74.

In addition, the dust collection box 80 has the inner case 84, and the inner case 84 is disposed adjacent to the right side of the side cover wall 61 in the saw cover 60 and is made of a metal. That is, the part on the saw blade 12 side in the dust collection box 80 is made of a metal. Accordingly, while thermal deformation of the dust collection box 80 is curbed, the inner case 84 can be cooled by an air flow generated during rotation of the saw blade 12. Therefore, heat resistance of the dust collection box 80 can be improved. The side cover wall 61 is an example of a partitioning part according to the present invention and is a member for partitioning the tool accommodation region AR (first space) and the chip accommodation part 80A (second space). Since the inner case 84 serving as a protective member is provided between the chip accommodation part 80A (second space) and the side cover wall 61, deformation of the side cover wall 61 due to chips can be curbed. Therefore, since a situation in which the side cover wall 61 is deformed and movement of the saw blade 12 and the protective cover 55 is hindered can be curbed, workability can be improved. That is, the inner case 84 is an example of a protective member. If the cover member 70 is a first protective member, the inner case 84 is a second protective member.

In addition, the dust collection box 80 has the outer case 82, and the outer case 82 covers the inner case 84 from a side opposite to the saw cover 60 (right side) and is constituted using a transparent material. Accordingly, the inside of the dust collection box 80 can be visually recognized by means of the outer case 82 so that the amount or the state of chips accumulated inside the dust collection box 80 can be checked. Therefore, convenience for a worker can be improved.

In addition, the inner case 84 of the dust collection box 80 is provided with the stopper wall 84C bent to the right side, and the stopper wall 84C is disposed on the rear side of the box entrance section 84B. That is, the stopper wall 84C is disposed inside the dust collection box 80 and is disposed on the rotation direction side (rear) of the saw blade 12 with respect to the exit part 64C of the chip discharge passage section 64 in the saw cover 60. Accordingly, chips discharged to the right side and the side of the saw blade 12 in the rotation direction from the exit part 64C of the chip discharge passage section 64 collide with the stopper wall 84C, and fall down inside the dust collection box 80 after collision. For this reason, abutment of chips discharged from the exit part 64C with respect to the outer case 82 can be curbed. Therefore, thermal deformation of the outer case 82 can be curbed, and heat resistance of the dust collection box 80 can be further improved.

In addition, the box bottom part 84F bent to the right side is formed in the lower end part of the inner case 84 of the dust collection box 80, and the box bottom part 84F covers the inner circumferential surface of the lower wall of the outer case 82 from the upper side. That is, the box bottom part 84F constitutes the bottom part inside the dust collection box 80 (chip accommodation part 80A). Accordingly, inside the dust collection box 80, chips are stored on the box bottom part 84F. Namely, direct contact of chips stored inside the dust collection box 80 with the lower wall of the outer case 82 can be prevented. In addition, since the box bottom part 84F is connected the inner case 84 (facing portion on the saw cover 60 side) having a large area, heat of the chips stored in the bottom part inside the dust collection box 80 can escape to the inner case 84 from the box bottom part 84F, a temperature rise of the bottom part is curbed, and cooling of stored chips can also be quickly performed. In addition, it is constituted such that a large amount of heat can also be quickly dissipated by setting the upper end position of the inner case 84 to be higher than the upper end position of the saw blade 12. Therefore, thermal deformation of the outer case 82 can be further curbed, and heat resistance of the dust collection box 80 can be further improved.

In addition, a plurality of first ventilation holes 61F and a plurality of second ventilation holes 61G are formed in the side cover wall 61 of the saw cover 60. Accordingly, an air flow generated during rotation of the saw blade 12 can pass through the insides of the first ventilation holes 61F and the second ventilation holes 61G and can abut the inner case 84 of the dust collection box 80. For this reason, the inner case 84 can be cooled by the air flow. Therefore, heat resistance of the dust collection box 80 can be effectively improved. Particularly, since the inner case 84 faces the region accommodating operational components such as the saw blade 12 and the protective cover 55 (first space), for example, when the inner case 84 or the side cover wall 61 is deformed or the like due to heat of the chips accumulated inside the dust collection box 80, there is concern that operation of operational components such as the saw blade 12 and the protective cover 55 may become defective. However, according to the present embodiment, occurrence of such a situation can be curbed. In addition, as illustrated in (B) of FIG. 10, the first ventilation holes 61F include holes facing the region in which the protective cover 55 operates. For example, when chips are accumulated between the protective cover 55 and the side cover wall 61 in a sandwiched form, there is concern that movement of the protective cover 55 may be hindered, but the first ventilation holes 61F can curb accumulation of chips between the protective cover 55 and the side cover wall 61. That is, chips which may be accumulated between the protective cover 55 and the side cover wall 61 are discharged to the outside of the tool accommodation region AR (first space) through the first ventilation holes 61F. Therefore, movement of the protective cover 55 can be favorably maintained, and workability can be secured.

In addition, a plurality of abutment ribs 61H protruding to the right side (dust collection box 80 side) is formed in the side cover wall 61 of the saw cover 60. Specifically, the abutment ribs 61H are disposed on the outward side of the side cover wall 61 in the radial direction and the inward side thereof in the radial direction with respect to the first ventilation holes 61F. Further, the inner case 84 of the dust collection box 80 is disposed adjacent to the right side of the abutment ribs 61H. Therefore, a predetermined gap can be formed between the side cover wall 61 and the inner case 84 in the lateral direction. In other words, the abutment ribs 61H restrict approach of the side cover wall 61 to the inner case 84 and make a gap. Accordingly, the inner case 84 can be more favorably cooled by causing air which has passed through the first ventilation holes 61F to flow into the gap. Therefore, heat resistance of the dust collection box 80 can be more effectively improved. In addition, since the gap is provided, chips discharged through the first ventilation holes 61F described above are favorably discharged to the outside.

In addition, the narrow part 61E which is lowered to the left side (a side opposite to the dust collection box 80) by one step is formed in the side cover wall 61 of the saw cover 60, and the second ventilation holes 61G are formed in the narrow part 61E. For this reason, a predetermined gap can be formed between the narrow part 61E and the inner case 84. Accordingly, the inner case 84 can be cooled by causing air which has passed through the second ventilation holes 61G to flow into the gap. Therefore, heat resistance of the dust collection box 80 can be more effectively improved. The narrow part 61E is positioned outside the region in which the right side portion of the protective cover 55 operates. For this reason, a predetermined gap can be provided between the narrow part 61E and the inner case 84.

In addition, the side cover wall 61 of the saw cover 60 is formed to have a semicircular fan shape opening to the lower side in a side view, and the cover-side cutout part 61A opening to the lower side is formed in the intermediate part of the lower end part of the side cover wall 61 in the forward-rearward direction. Further, in a state in which the dust collection box 80 is detached from the tool main body 20, the bolt BL for fixing the saw blade 12 is exposed. Accordingly, replacement work of the saw blade 12 can be performed through the cover-side cutout part 61A.

In addition, the dust collection box 80 has the attachment/detachment button 86 configured to be able to engage with the saw cover 60. The attachment/detachment button 86 is accommodated in the button accommodation part 82D of the outer case 82, and the button engagement piece 86B of the attachment/detachment button 86 is inserted into the button insertion groove 84D of the inner case 84. Further, the width measurement of the button insertion groove 84D is set to be slightly larger than the width measurement of the button engagement piece 86B. Accordingly, the position of the attachment/detachment button 86 in the forward-rearward direction can be determined by the inner case 84. In addition, since the stopper wall 84C covers and protects the wall on the front side dividing the button accommodation part 82D, deformation of the button accommodation part 82D causing an operational defect of the attachment/detachment button 86 can be curbed.

Hereinabove, the present invention has been described based on the embodiment described in FIGS. 1 to 13. However, the present invention is not limited to the embodiment described above, and various changes can be made within a range not departing from the gist thereof.

The present invention realizes a work machine with improved workability by securing the durability. More specifically, the present invention curbs a situation in which deformation of the partitioning part adversely affects movement of movable components such as the saw blade 12 and the protective cover 55 or a situation in which movement of chips is adversely affected. Therefore, the work machine according to the present invention may be configured to include the first space (tool accommodation region AR) accommodating the saw blade 12 and the protective cover 55, the second space including at least one of the passage space (chip discharge passage section 64) through which machining chips generated during work by the saw blade 12 pass or the accommodation space (chip accommodation part 80A) in which machining chips are collected, and the partitioning part partitioning the first space and the second space. The protective member (guard member 70) may be provided in the region between the first space and the partitioning part, the region between the second space and the partitioning part, or the partitioning part.

When the protective member (guard member 70) is positioned in the region between the first space and the partitioning part, since the protective member (guard member 70) is exposed to the first space, deformation due to contact of machining chips from the first space with the partitioning part (lower surface of the inward side cover wall 63) can be curbed. Furthermore, even if the partitioning part is deformed due to an external cause (an impact or heat) causing deformation from the second space side, deformation of the partitioning part causing interference with the first space can be curbed by the protective member. For example, even if the partitioning part melts due to heat from the second space side, movement of the melted partitioning part can be hindered by the protective member maintaining the shape. Therefore, a situation in which deformation of the partitioning part affects the members operating inside the first space can be curbed. In this case, the partitioning part and the protective member may not come into contact or may come into contact with each other.

In addition, when the protective member (guard member 70) is positioned in the region between the second space and the partitioning part, machining chips moving in the second space no longer directly abut the partitioning part. Therefore, deformation of the partitioning part (upper surface of the inward side cover wall 63) can be directly curbed. In this case as well, the partitioning part and the protective member may not come into contact or may come into contact with each other.

In addition, when the protective member (guard member 70) is provided in the partitioning part as well, deformation of the partitioning part is curbed. The expression “being provided” mentioned herein not only includes a case of being attached to the side surface of the partitioning part but also includes a case of being integrally constituted with the partitioning part. For example, it includes a constitution in which the guard member and the saw cover 60 are integrally molded such that the guard member is positioned at the internal center of the partitioning part. In this case, transfer of a deformation force (an impact or heat) applied from one of the first space and the second space to the other is curbed inside the partitioning part. Therefore, for example, even if the side surface of the partitioning part facing the second space melts due to heat, the thermal deformation thereof is curbed in the middle of the partitioning part, and deformation of the side surface of the partitioning part facing the first space is curbed.

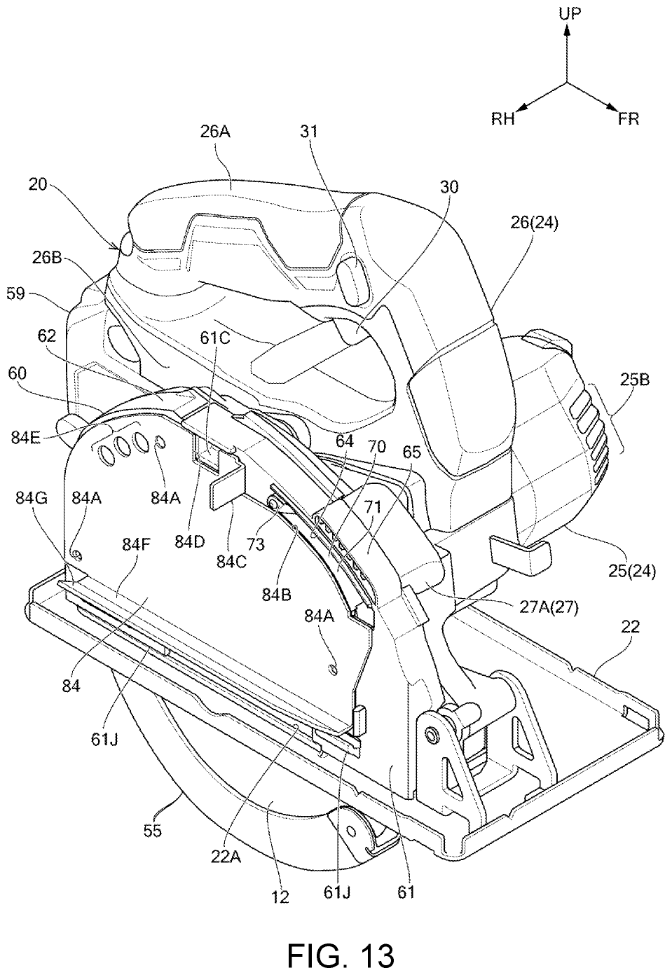

A modification example according to the embodiment of the present invention will be described using FIGS. 13 to 18. In the modification example, the saw cover 60 and the dust collection box 80 are changed compared to the embodiment described above, and other parts are similar thereto so that description thereof will be omitted. In addition, in the modification example, portions having a function similar to that in the embodiment described above have reference signs set by adding 100 to the number. For example, a side cover wall 161 described in FIG. 14 has a function similar to that of the side cover wall 61 described in FIG. 4 and the like. Hereinafter, description of structures basically having a similar function will be omitted, and description will be given focusing on details of changed parts.

FIG. 14 illustrates a view of a state in which a saw cover 160 and a dust collection box 180 in a state of being attached to the saw cover 160 according to the modification example are viewed in the left forward direction. Similar to the embodiment described above, the side cover wall 161, an outer circumferential cover wall 162, and an inward side cover wall 163 are provided in the saw cover 160. A ventilation hole 161F, a narrow part 161E, and a hook reception part 161J are provided in the side cover wall 161. In the region between the outer circumferential cover wall 162 and the inward side cover wall 163, a chip discharge passage section 164 is provided in the front portion. A cover-side intake part 165 is provided in the upper part of the front portion of the outer circumferential cover wall 162. A cover member 170 is provided in the front upper part of the inward side cover wall 163. The cover member 170 basically has a structure similar to that of the cover member 70 described above but differs therefrom in that the guard-side entrance guide 74 is not provided.

The dust collection box 180 is attached to the right side of the saw cover 160. The left side surface of the dust collection box 180 is formed as a (second) protective member by an inner case 184, and a portion of the inner case 184 is seen through the ventilation hole 161F in FIG. 14. A box-side intake part 182C is formed in the front upper part of the dust collection box 180 and communicates with the cover-side intake part 165.

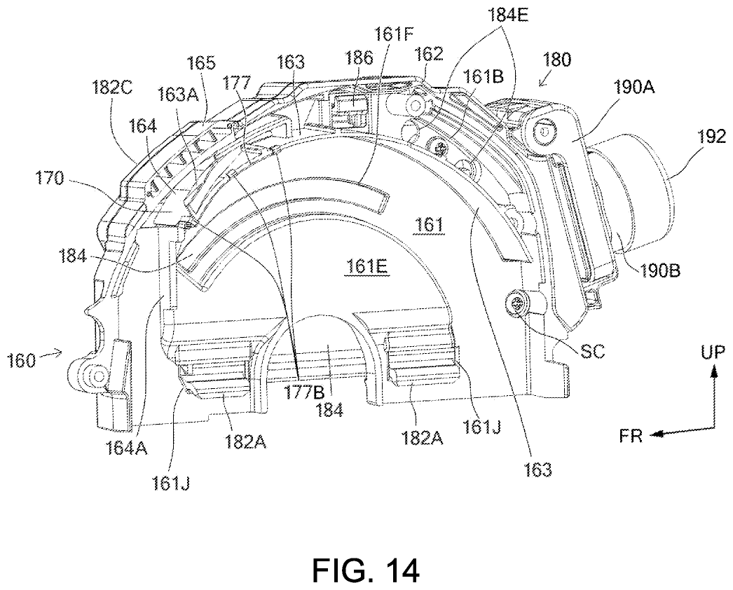

FIG. 15 is a partially enlarged view of the front portion of the inward side cover wall 163 viewed from the lower left in the rear. As illustrated in FIGS. 14 and 15, a cover member 177 serving as a third protective member is provided in the front lower part of the inward side cover wall 163. The cover member 177 is a member covering the lower surface of the inward side cover wall 163 (partitioning part) positioned between the space (first space) in which the saw blade 12 is positioned and the chip discharge passage section 164 (second space) and is a protective member positioned in the region between the inward side cover wall 163 (partitioning part) and the space (first space) in which the saw blade 12 is positioned. The cover member 177 has a cover part 177A covering the lower surface of the inward side cover wall 163, and a claw part 177B engaging with the left end of the inward side cover wall 163. Due to engagement of the claw part 177B with the inward side cover wall 163, the cover member 177 is supported by the inward side cover wall 163 (saw cover 160). Large projection parts 161L protruding to the left is provided in the side cover wall 161 of the saw cover 160. Two large projection parts 161L are provided apart from each other in the forward-rearward direction. Small projection parts 161K protruding to the left are provided in the side cover wall 161 of the saw cover 160. The small projection parts 161K are positioned between two large projection parts 161L in the forward-rearward direction. The large projection parts 161L are configured to be able to come into contact with and support the lower surface of the cover member 177 and curb downward movement (positional deviation) of the cover member 177. The small projection parts 161K engage with cutout parts 177C of the cover member 177 and curb movement (positional deviation) of the cover member 177 in the lateral direction.

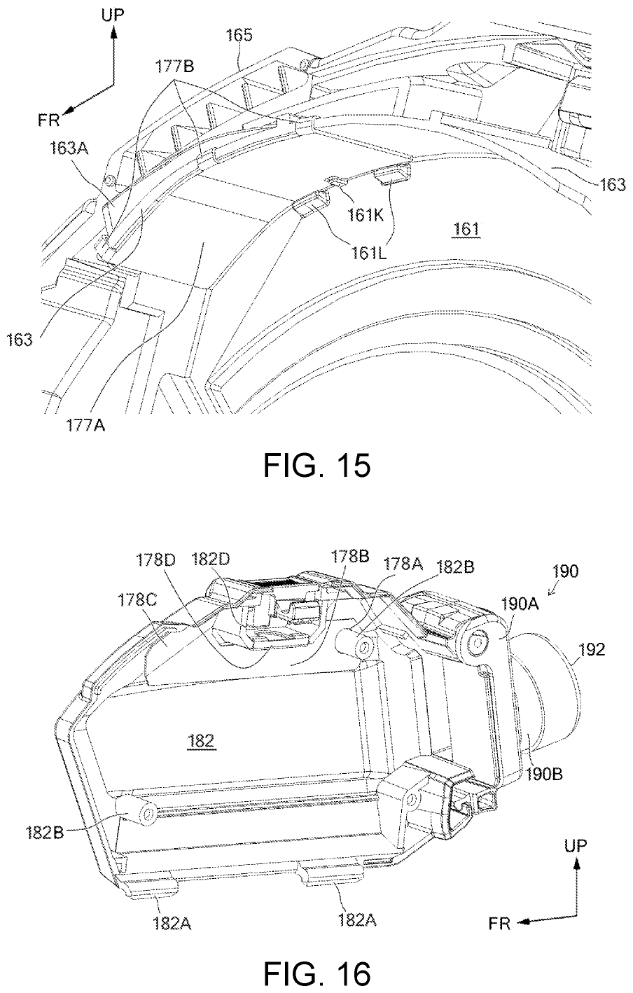

FIG. 16 is a view of a state in which the saw cover 160 is eliminated from the state in FIG. 14. A cover member 178 serving as a new (fourth) protective member is provided on the inward side of an outer case 182 in the dust collection box 180 according to the modification example. The cover member 178 has a hole part 178A provided in the rear part, a base part 178B, a bending part 178C connected to the front upper part of the base part 178B, and a claw part 178D for performing positioning. A fixing boss 182D is insert through the hole part 178A, and the cover member 178 is supported by the fixing boss 182D.

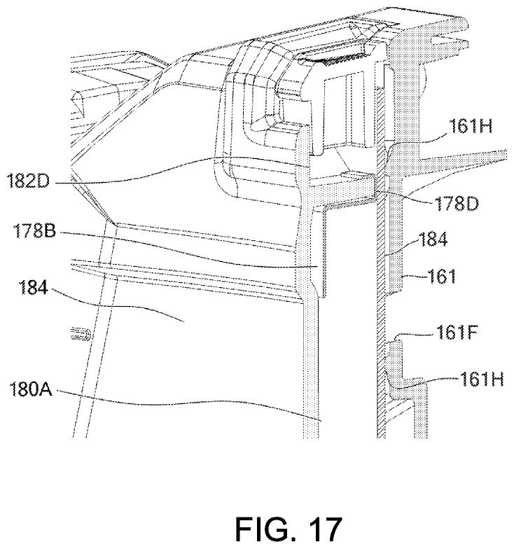

FIG. 17 is a partially enlarged view of a cross-sectional view in FIG. 14 cut along vertical and lateral planes passing through the rear part of the claw part 178D viewed from above in the right front. As illustrated in FIG. 17, the claw part 178D is sandwiched by the bottom part of a button accommodation part 182D and an inner case 182. Accordingly, the cover member 178 is supported. The ventilation hole 161F faces the operation region of a protective cover (not illustrated) and curbs storing of dust between the protective cover and the side cover wall 161. Abutment ribs 161H are provided in the side cover wall 161. The abutment ribs 161H abut the inner case 182, thereby forming a predetermined gap (space) between the side cover wall 161 and the inner case 182. Chips discharged from the ventilation hole 161F are discharged to the outside from the gap.

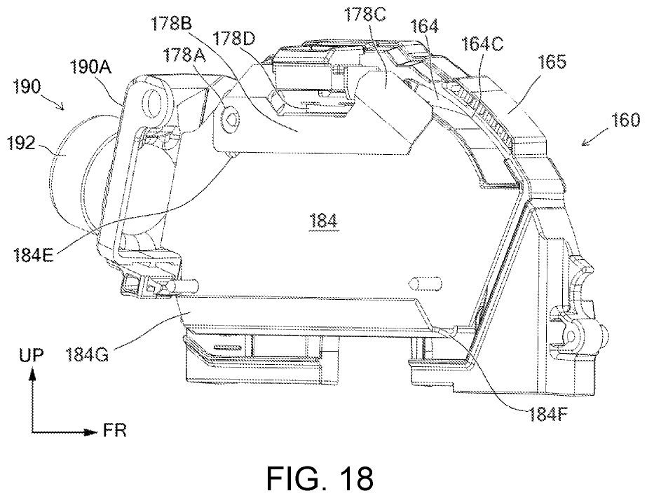

FIG. 18 is a view of a state in which only the outer case 182 is eliminated from the state in FIG. 14 viewed from the right in the front. Therefore, FIG. 18 illustrates the cover member 178 supported by the outer case 182 such that it is floating. A base part 178 of the cover member 178 and the bending part 178C are configured to partially face an exit part 164C (opening of the chip discharge passage section 164 on the right side) such that chips discharged from the exit part 164C can abut. That is, the cover member 178 curbs contact of chips with a portion of the dust collection box 180 (upper part on the inner surface of the outer case 182). Accordingly, deformation of a portion of the dust collection box 180 (upper part on the inner surface of the outer case 182) due to chips is curbed. In addition, the cover member 178 is provided in a region above the lower end of an exhaust part 164C and the lower end of a box-side exhaust outlet 184E. When chips accumulated in a chip accommodation part 180A are positioned above the lower ends of communication paths (the exhaust part 164C and the box-side exhaust outlet 184E) causing an accommodation part 180A and the outside to communicate with each other, there is concern that chips collected from the communication path may leak to the outside. For this reason, example according to the present invention is constituted such that the outer case 182 is made transparent and a worker can work while checking whether or not apex parts of gathered chips have exceeded the lower end of the communication path through the transparent outer case 184. For this reason, the lower region from the lower ends of the communication paths (the exhaust part 164C and the box-side exhaust outlet 184E) in the chip accommodation part 180A is utilized as a collection space for chips, and the upper region is scarcely necessary as a collection space. Therefore, in the present modification example, the durability of the dust collection box 180 can be improved without impairing workability of checking the stored condition of chips by providing the cover member 178 covering the inner surface portion of the outer case 182 positioned in the region above the lower ends of the communication paths (the exhaust part 164C and the box-side exhaust outlet 184E) causing the chip accommodation part 180A and the outside to communicate with each other during work. The opening part covered by a dust collector connection part 190 (mounted part 190A) during work does not correspond to the foregoing communication paths. A box bottom part 184F having a function similar to that of the box bottom part 84F described in FIG. 10 and the like, and an inclined part 184G formed in the box bottom part 184F are provided in the dust collection box 180. A portion of the box bottom part 184F extends upward from the bottom part inside the dust collection box 180 (accommodation part 180A), and this curbs a situation in which the lower part of the dust collection box 180 is excessively heated. The covering range of the box bottom part 184F is a range below the opening part covered by the dust collector connection part 190 (mounted part 190A) during work. Accordingly, the durability can be improved without impairing workability of checking the stored condition of chips.

The effects exhibited by the modification example will be described. In the modification example, not only the upper surface of the inward side cover wall 163 but the lower surface is also covered by the protective member (cover member 177). Accordingly, even if the inward side cover wall 163 is thermally deformed due to heat transmitted to the inward side cover wall 163 from the cover member 170 which has been intensely heated due to heat from a machining material such that it cannot dissipate the heat, movement of a melted portion of the inward side cover wall 163 toward the space in which the saw blade 12 is positioned (first space) can be favorably curbed by the protective member (cover member 177). That is, more favorable workability can be secured by covering both the first space side and the second space side of the partitioning part by the protective member. In addition, according to the work machine of the modification example, since the inner surface of the outer case 182 is covered by the protective member (cover member 178) in the region above the lower end of the communication paths (the exhaust part 164C and the box-side exhaust outlet 184E) causing the chip accommodation part 180A and the outside to communicate with each other, while it is configured to be able to check the stored condition of chips, deformation of the outer case 182 in the region can be curbed.

### REFERENCE SIGNS LIST

10 Cutting tool (work machine)
12 Saw blade (tip tool)
41 Motor
60 Saw cover (cover)
63A Inclined wall (guide wall)
64 Chip discharge passage section (discharge passage section)
64B Entrance part
64C Exit part
70 Guard member
72 Guard-side inclined wall (guide guard)
74 Guard-side entrance guide (entrance guide part)
80 Dust collection box
82 Outer case (second case)
84 Inner case (first case)
84C Stopper wall (stopper part)
84F Box bottom part (cover part)

1. A work machine comprising:
a first space in which a circular tip tool driven by a motor is positioned;
a second space including at least one of a passage space through which machining chips generated during work by the circular tip tool pass or an accommodation space in which the machining chips are collected; and
a partitioning part made of resin and partitioning the first space and the passage space in a radial direction of the circular tip tool,
wherein a protective member is provided in a region between the first space and the partitioning part in the radial direction, a region between the passage space and the partitioning part in the radial direction, or the partitioning part.

2. The work machine according to claim 1,
wherein the protective member is harder or has higher heat resistance than the partitioning part or has both the properties.

3. The work machine according to claim 1,
wherein the protective member is provided such that the protective member is provided in the region between the first space and the partitioning part and at least a portion is exposed to the first space or the protective member is provided in the region between the passage space and the partitioning part and at least a portion is exposed to the passage space.

4. The work machine according to claim 1,
wherein the protective member is attached to the partitioning part.

5. The work machine according to claim 1 further comprising:
a cover covering at least a portion of the circular tip tool,
wherein the partitioning part is provided in the cover.

6. A work machine comprising:
a motor for driving a circular tip tool;
a cover covering at least a portion of the circular tip tool;
a discharge passage section provided in the cover and discharging machining chips generated during machining work using the circular tip tool; and
a guard member positioned inside the discharge passage section and covering a wall part positioned at radially outside of the circular tip tool.

7. The work machine according to claim 6,
wherein a dust collection box for storing machining chips discharged from the discharge passage section is attached to the cover.

8. The work machine according to claim 7,
wherein the discharge passage section has
an entrance part opening to the circular tip tool side, and
an exit part opening to the dust collection box side, and
wherein the guard member is provided inside a path leading from the entrance part to the exit part.

9. The work machine according to claim 7,
wherein the dust collection box is configured to include
a first case disposed adjacent to the cover, and
a second case covering the first case from a side opposite to the cover, and
wherein the first case is made of a metal, and the second case is made of a transparent material.

10. The work machine according to claim 9,
wherein the first case is provided with a stopper part in which machining chips discharged to the dust collection box from the discharge passage section abut.

11. The work machine according to claim 9,
wherein a cover part covering a portion on an inner circumferential surface of the second case is formed in the first case.

12. The work machine according to claim 11,
wherein the cover part covers at least a portion on an inner circumferential surface of a lower wall of the second case.

13. The work machine according to claim 9,
wherein the second case is constituted using a resin material.

14. The work machine according to claim 7,
wherein a portion of the guard member extends to the dust collection box side beyond the discharge passage section.

15. The work machine according to claim 6,
wherein the discharge passage section is provided with a guide wall for guiding the flowing machining chips to the dust collection box side, and
wherein the guard member is provided with a guide cover covering at least a portion of the guide wall.
